(19) United States
(12) Patent Application Publication
(10) Pub. No.: US 2024/0338081 A1
(43) Pub. Date: Oct. 10, 2024

(54) Wearable Device For Adjusting Haptic Responses Based On A Fit Characteristic

(71) Applicant: Meta Platforms Technologies, LLC, Menlo Park, CA (US)

(72) Inventor: Sudhanshu Rathod, Woodinville, WA (US)

(21) Appl. No.: 18/587,637

(22) Filed: Feb. 26, 2024

Related U.S. Application Data
(60) Provisional application No. 63/495,057, filed on Apr. 7, 2023.

(51) Int. Cl. G06F 3/01; G02B 27/01

(52) U.S. Cl. CPC G06F 3/016; G02B 27/017; G06F 3/014

(57) ABSTRACT

Described herein is an example computer-readable storage medium that includes instructions that, when executed by an artificial-reality system that includes a wearable device, cause the artificial-reality system to perform operations. These operations include that after a user has donned the wearable device on a body part of the user, obtaining, based on data from a sensor of the wearable device, one or more fit characteristics indicating how the wearable device fits on the body part of the user. The operations also include that after the user has donned the wearable device on a body part of the user, in accordance with a determination that the user is interacting with an object within an artificial reality presented via the artificial-reality system using the wearable device, providing a fit-adjusted haptic response based (i) on the one or more fit characteristics and (ii) an emulated feature associated with the object.

This claims the benefit of, and the priority to, U.S. Provisional Patent Application Ser. No. 63/495,057, entitled “Wearable Device for Adjusting Haptic Responses Based on A Fit Characteristic” filed Apr. 7, 2023, the disclosure of which is incorporated in its entirety by this reference.

### TECHNICAL FIELD

This relates generally to artificial-reality headsets, including but not limited to techniques for providing personalized haptic feedback at a wearable device based on one or more determined fit characteristics based on each user's unique physical attributes. For example, a wearable device (e.g., a wearable-glove device) can be configured to adjust a haptic feedback response to provide a better emulation of an artificial environment displayed at an artificial-reality headset (e.g., virtual reality displayed at a virtual reality headset) for a specific user.

### BACKGROUND

Traditional wearable devices have been configured to provide haptic feedback irrespective of how that haptic feedback is actually perceived by a user. Not having personalized haptic feedback can lead to a less immersive experience as the haptic feedback received may not match the expected feedback for some users. For example, a haptic feedback may be too strong with user's with larger features because the wearable device is too taught around their body. Having a wearable device that provides varying perceived haptic feedback responses based on a person's physical features is undesirable as it makes for an inconsistent experience for end users.

As such, there is a need to address one or more of the above-identified challenges. A brief summary of solutions to the issues noted above are described below.

### SUMMARY

The methods, systems, and devices described herein allow for wearable devices to provide consistent haptic responses to users with varying sizes and compositions, ensuring that the desired haptic feedback response is administered to the broadest range of wearers. Having the ability to tailor the perceived haptic feedback responses to individual users without having to require the user to change the size of the wearable device or go into a settings menu to alter the haptic is highly convenient. Consistency in haptic feedback across multiple users also ensures the designer of the experience is also able to provide the desired sensation to the widest audience.

One example of a system that resolves the issues describe includes, non-transitory computer-readable storage medium that includes instructions that, when executed by an artificial-reality system that includes a wearable device (e.g., a glove, a wrist-worn wearable device, head-worn wearable device, etc.), cause the artificial-reality system to perform operations including: after a user has donned the wearable device on a body part of the user, obtaining, based on data from a sensor of the wearable device, one or more fit characteristics indicating how the wearable device fits on the body part of the user; and in accordance with a determination that the user is interacting with an object within an artificial reality presented via the artificial-reality system using the wearable device, providing a fit-adjusted haptic response based (i) on the one or more fit characteristics and (ii) an emulated feature associated with the object.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A-1J illustrate users interacting with an artificial reality and administering a personalized haptic feedback based on a determined fit characteristic of the wearable device to the respective user's hands, in accordance with some embodiments.

FIGS. 2A-2B illustrate two example embodiments of haptic feedback generators that are configured to provide a haptic feedback to a user, in accordance with some embodiments.

FIG. 3 illustrates an outer layer of a wearable-glove device that is configured for detecting capacitive inputs at each phalanx of the finger, in accordance with some embodiments.

FIG. 4 shows an example method flow chart for providing a personalized haptic response, in accordance with some embodiments.

FIGS. 5A-5E illustrate an example wrist-wearable device, in accordance with some embodiments.

FIGS. 6A-6B illustrate an example AR system in accordance with some embodiments.

FIGS. 7A and 7B are block diagrams illustrating an example artificial-reality system in accordance with some embodiments.

FIG. 8 is a schematic showing additional components that can be used with the artificial-reality system of FIGS. 7A and 7B, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

Embodiments of this disclosure can include or be implemented in conjunction with various types or embodiments of artificial-reality systems. Artificial reality, as described herein, is any superimposed functionality and or sensory-detectable presentation provided by an artificial-reality system within a user's physical surroundings. Such artificial-realities (AR) can include and/or represent virtual reality (VR), augmented reality, mixed artificial-reality (MAR), or some combination and/or variation one of these. For example, a user can perform a swiping in-air hand gesture to cause a song to be skipped by a song-providing API providing playback at, for example, a home speaker. In some embodiments of an AR system, ambient light (e.g., a live feed of the surrounding environment that a user would normally see) can be passed through a display element of a respective head-wearable device presenting aspects of the AR system. In some embodiments, ambient light can be passed through respective aspect of the AR system. For example, a visual user interface element (e.g., a notification user interface element) can be presented at the head-wearable device, and an amount of ambient light (e.g., 15-50% of the ambient light) can be passed through the user interface element, such that the user can distinguish at least a portion of the physical environment over which the user interface element is being displayed.

Artificial-reality content can include completely generated content or generated content combined with captured (e.g., real-world) content. The artificial-reality content can include video, audio, haptic events, or some combination thereof, any of which can be presented in a single channel or in multiple channels (such as stereo video that produces a three-dimensional effect to a viewer). Additionally, in some embodiments, artificial reality can also be associated with applications, products, accessories, services, or some combination thereof, which are used, for example, to create content in an artificial reality and/or are otherwise used in (e.g., to perform activities in) an artificial reality.

The descriptions provided below further detail how haptic responses can be adjusted to provide user specific responses, which allows for a more immersive interaction with an artificial reality.

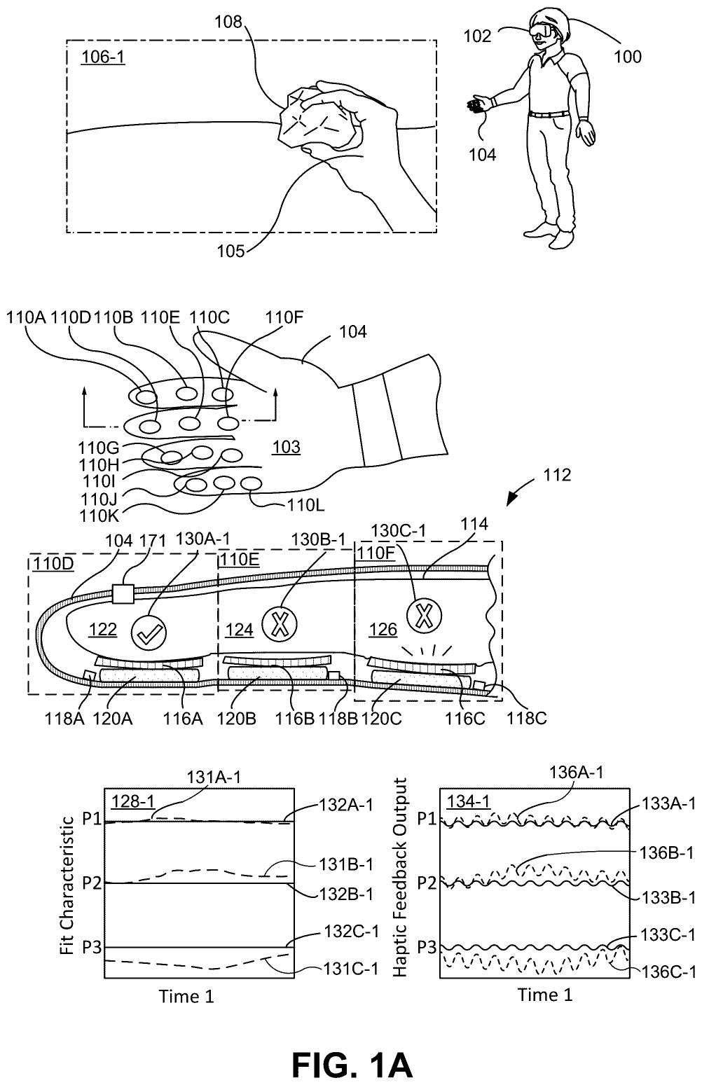

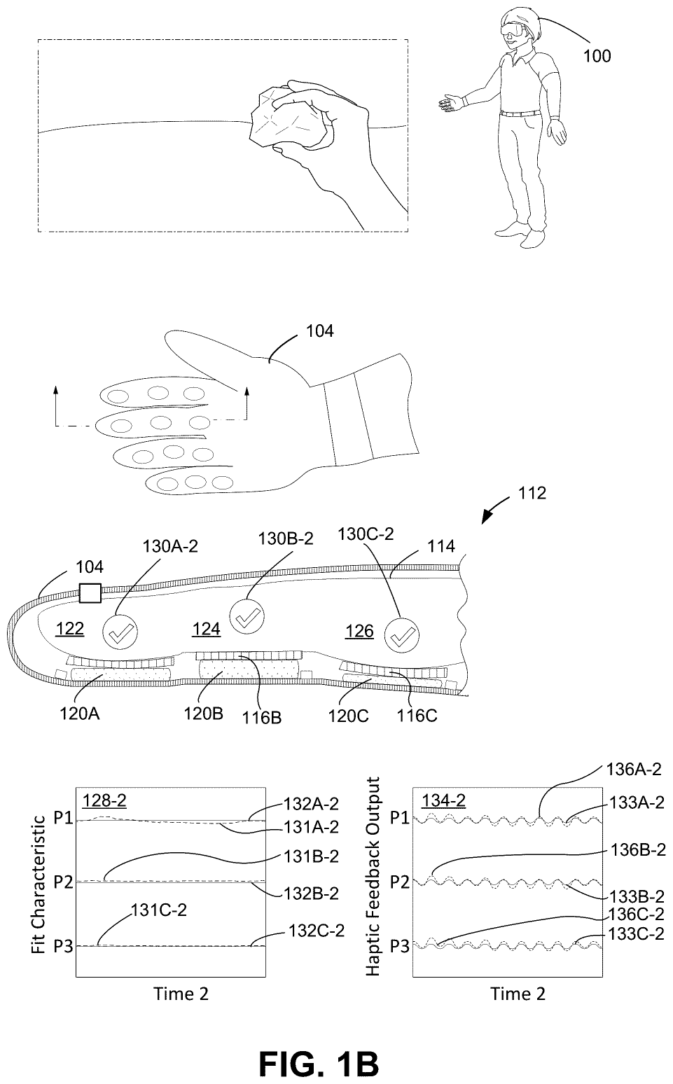

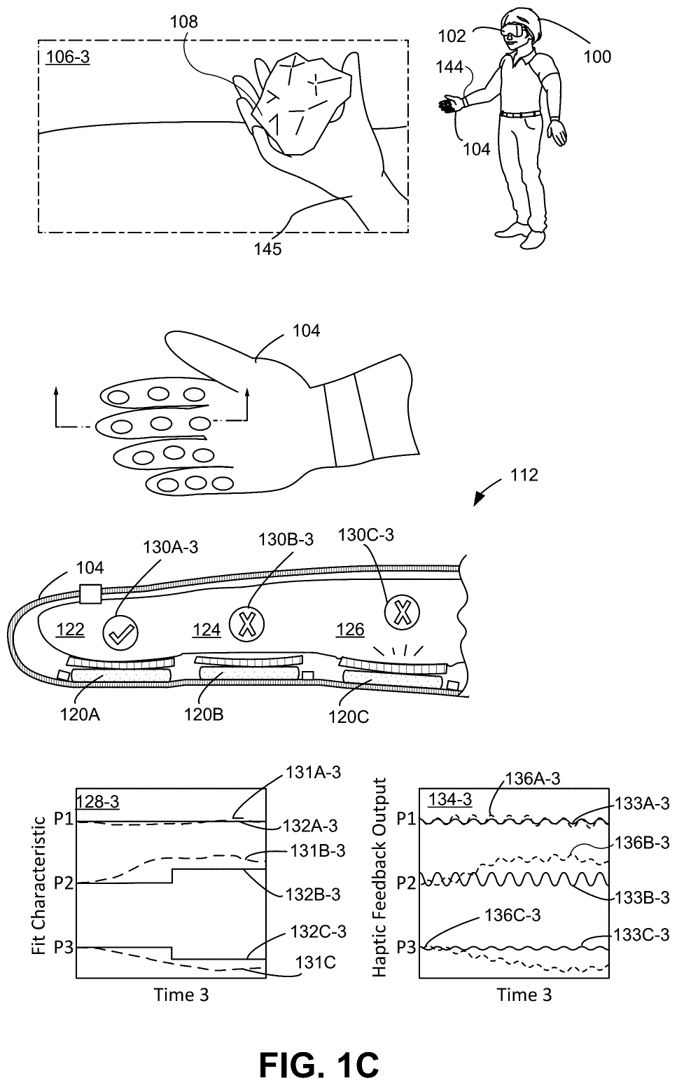

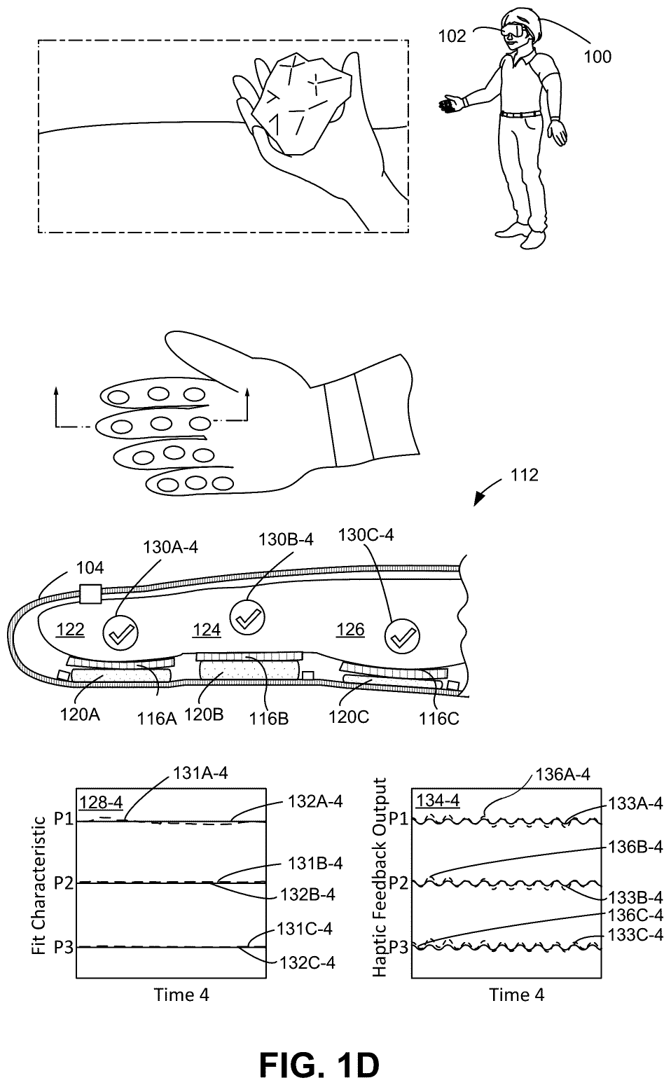

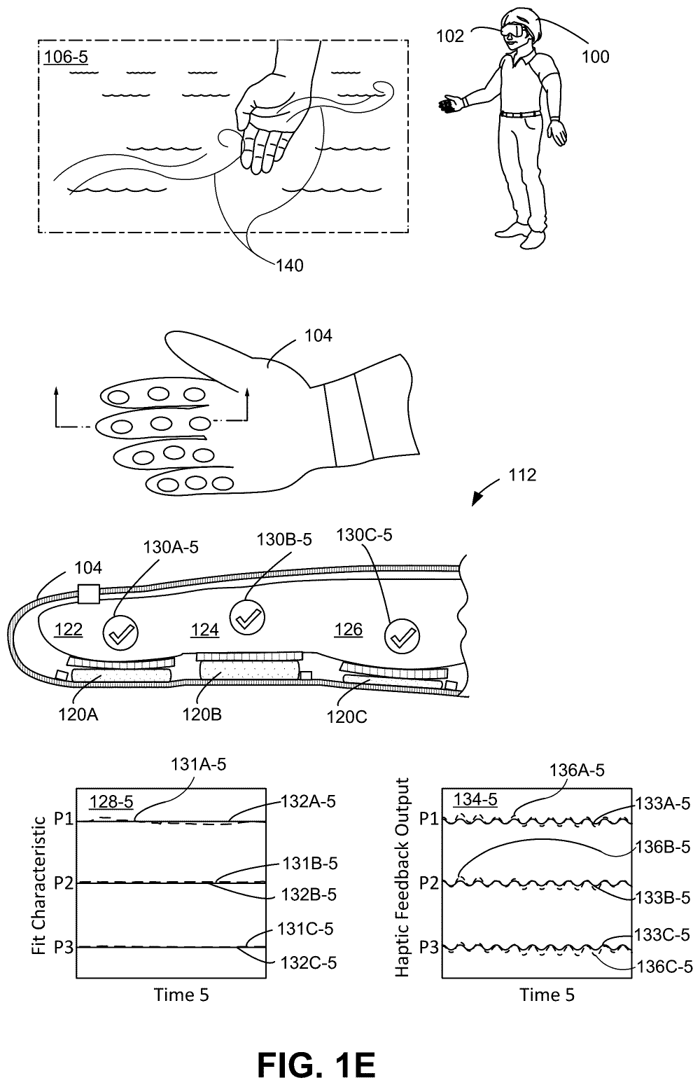

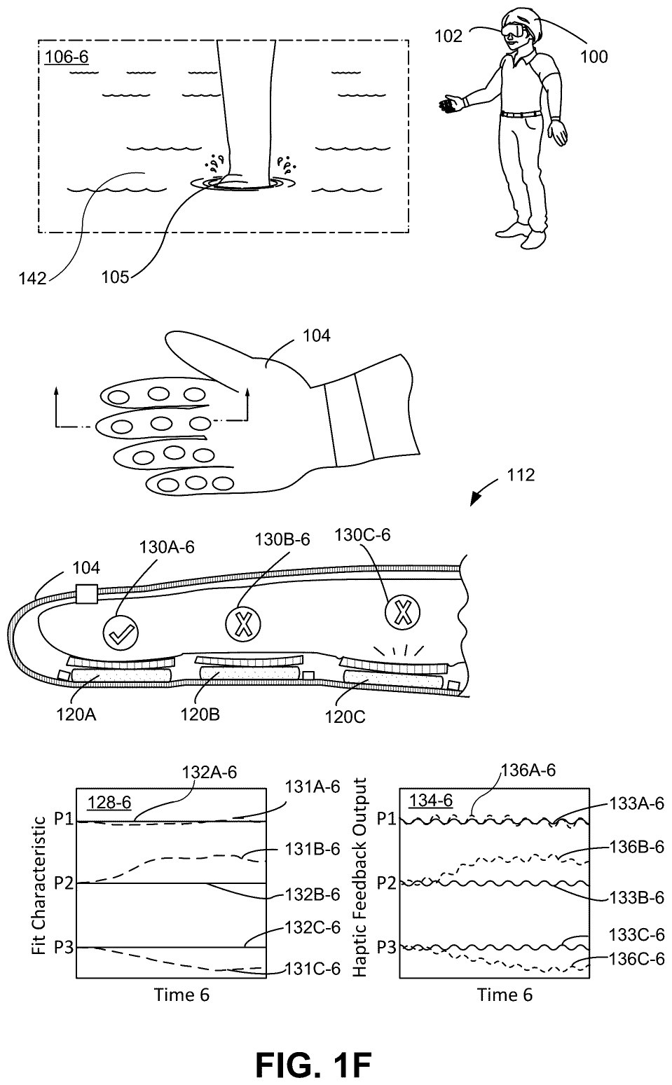

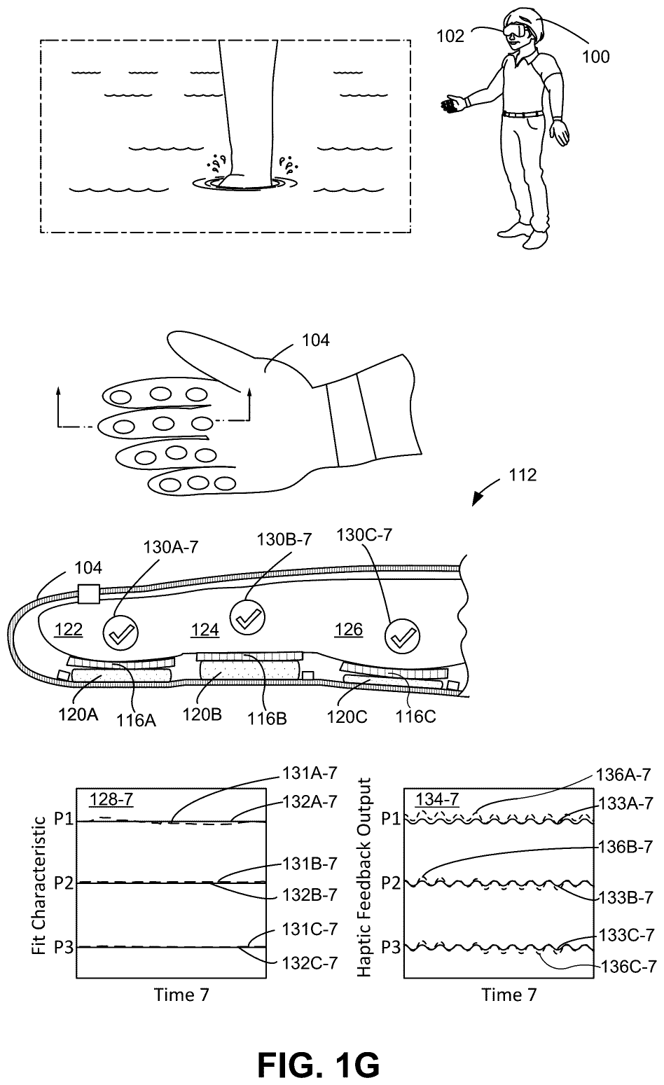

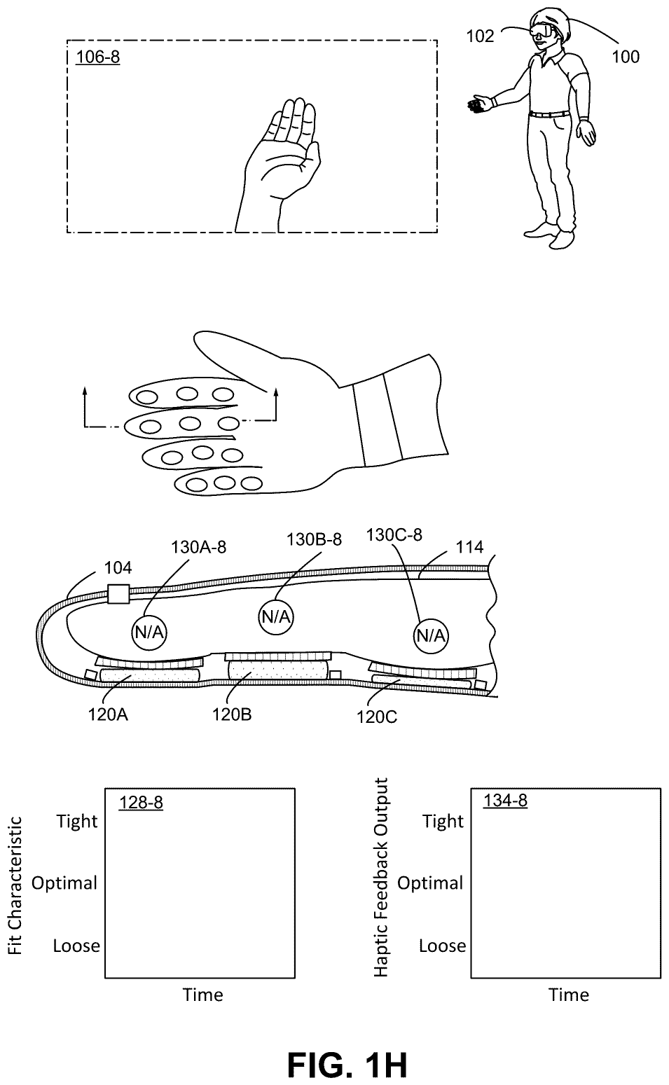

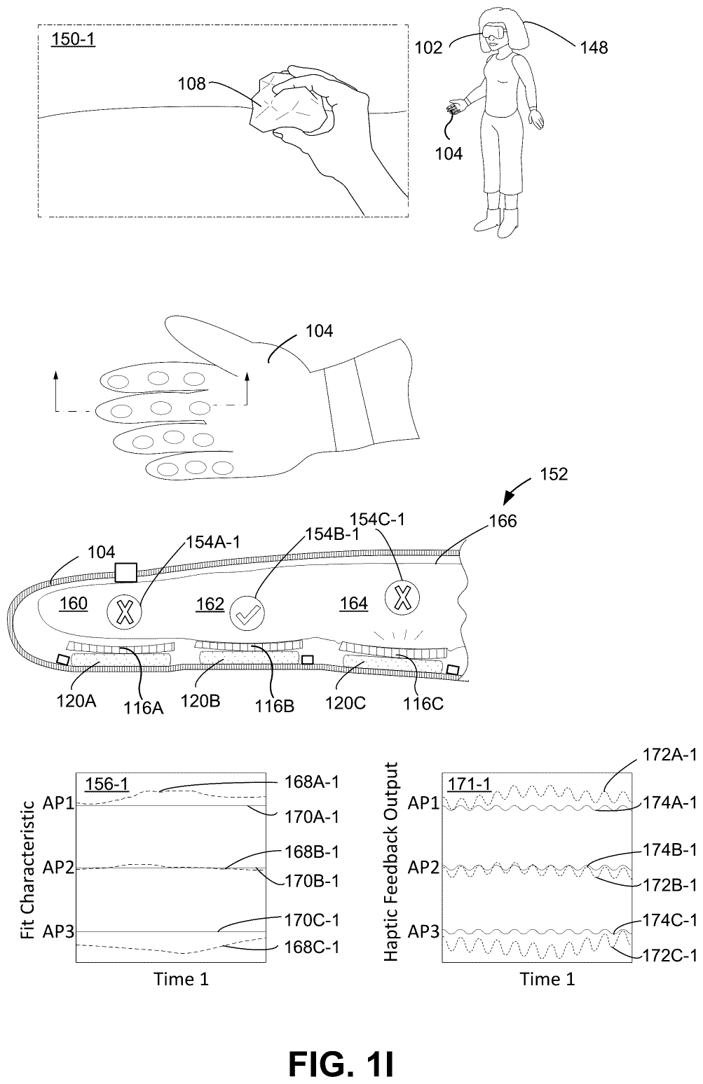

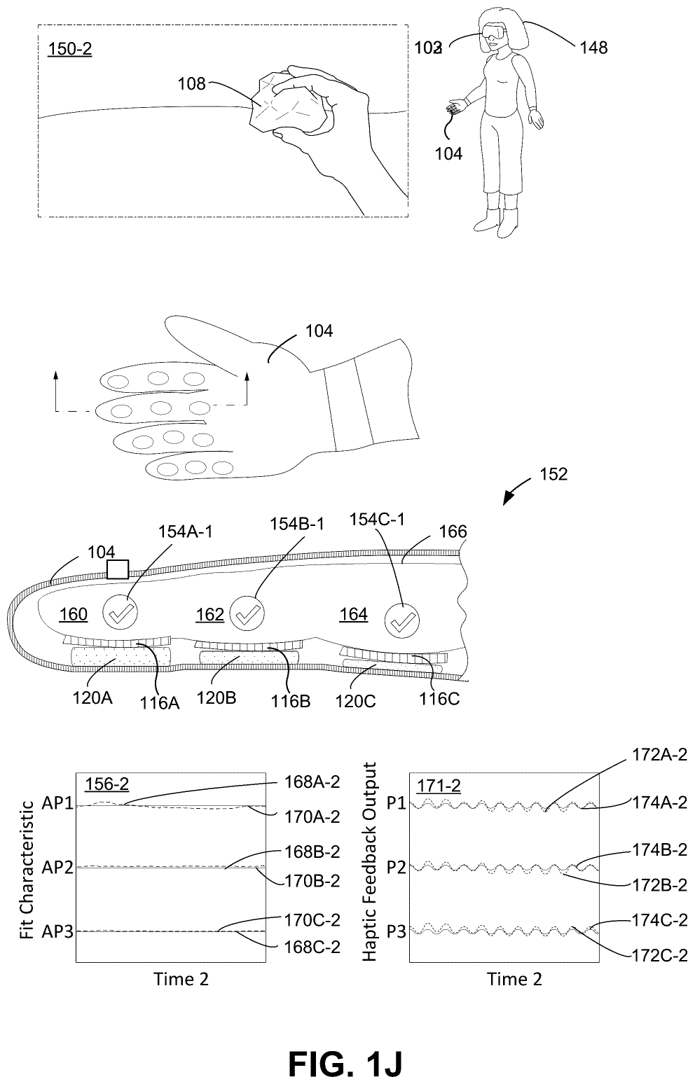

FIGS. 1A-1I illustrates users interacting with an artificial reality and administering a personalized haptic feedback based on a determined fit characteristic of the wearable device to the respective user's hands, in accordance with some embodiments. FIG. 1A shows a user 100 wearing an artificial-reality headset 102 and also wearing wearable-glove device 104 at a first point in time, t1. While this Figure and subsequent Figures focus on a wearable-glove device 104, the features described herein can be applied to any body worn garment, for example, a headset device, a wrist-worn device, an ankle-worn device, a beanie/hat device, a shirt device, pants device, socks device, etc.,

FIG. 1A also shows a user interface 106-1 that is being displayed at the artificial reality-headset 102. In this user interface 106-1, the user 100 is interacting with an artificial-reality rock 108 with their hand (e.g., virtual displayed hand 105) displayed at the artificial-reality headset 102. The haptic feedback described herein corresponds to interacting with the artificial-reality rock 108.

Beneath the depiction of the user interface 106-1, a palmar side 103 of the wearable-glove device 104 is shown that includes a plurality of haptic feedback zones (110A-110L). While this example shows the haptic feedback zones on the palmer side of the fingers these haptic feedback zones can be on any portion of the wearable-glove device 104, including, for example, the dorsal side of the fingers, dorsal and palmar side of the thumb, palm-side of hand, and dorsal-side of the user's hand.

In some embodiments, the wearable-glove device 104 also includes one or more sensors 171, which can be for example, an inertial measurement units (IMU) embedded in the wearable-glove device 104 or integrated into the one or more sensors coupled to the wearable-glove device 104. In some embodiments, the sensors 171 are located on different parts of the wearable-glove device 104 such as on each phalanx of each finger (as illustrated in FIGS. 1I-1J). The sensors 171 and/or sensors 118A-118C are configured to obtain one or more fit characteristics indicating how the wearable-glove device 104 fits on the body part of the user 100. In some embodiments, a single sensor 171 is associated with each haptic feedback zone 110A-110L.

FIG. 1A shows a cut-away view 112 of a middle finger 114 corresponding to the middle finger (labeled 1C) shown on the palmar side of the wearable-glove device 104. The cut-away view 112 shows that each phalanx is associated with at least one haptic feedback generator (i.e., haptic feedback generators 116A-116C). In some embodiments, each phalanx is also associated with a sensor (i.e., sensors 118A-118C) for obtaining one or more fit characteristics indicating how the wearable-glove device 104 fits on the user's finger, and in some embodiments, these can include the IMU sensor(s) described above. In some embodiments, a single sensor is configured to detect multiple phalanges respective fit characteristics. In some embodiments, cut-away view 112 also shows that each portion of the wearable-glove device 104 associated with a component, such as an inflatable/defaultable portion (e.g., pneumatically inflatable/defaultable, hydraulically inflatable/defaultable, mechanically tightening/loosing) 120A-120C that is configured to loosen or tighten the wearable-glove device 104 about each phalange. Similar approaches can also be used on the palmer/dorsal side of the wearable-glove device 104.

Cut-away view 112 also shows that a distal phalanx 122 (hereinafter also referred to as “P1 122”), a middle phalanx 124 (hereinafter also referred to as “P2 124”), and a proximal phalanx 126 (hereinafter also referred to as “P3 126”) each having their own respective determined fit characteristic 130A-1, 130B-1, and 130C-1. Beneath cut-away view 112, a chart 128-1 is shown which plots the determined fit characteristics to a nominal fit characteristics. Chart 128-1 shows a plurality of determined fit characteristic lines (131A-1, 131B-1, and 131C-1) each corresponding to a determined fit characteristic 130A-130C of each of P1 122, P2 124, and P3 126 over time. Each of determined fit characteristic line 131A-1-131C-1 is plotted with a respective nominal lines 132A-1, 132B-1, and 132C-1 which, illustrates a respective 131A-1, 131B-1, and 131C-1 deviation from a nominal fit characteristic (e.g., indicated by respective nominal fit characteristic lines 132A-1, 132B-1, and 132C-1. For example, a fit characteristic can include tightness of the wearable-glove device 104 about a phalanx, looseness of the wearable-glove device 104 about a phalanx, haptic feedback generators reverberation into the user's body (e.g., does the user's body under or over dampen a haptic feedback), etc. As shown in chart 128-1, a determined fit characteristic of P1 130A-1, as indicated by line 131A-1, is within a predefined limit of a nominal fit characteristic. Chart 128-1 also shows a determined fit characteristic of P1 130A-1, as indicated by line 131B-1, is exceeding a predefined limit of a nominal fit characteristic, and a determined fit characteristic of P1 130A-1, as indicated by line 131C-1, is not exceeding a predefined limit of a nominal fit characteristic.

FIG. 1A also shows a chart 134-1 that plots the recorded haptic feedback against a nominal haptic feedback when the wearable-glove device 104 fits properly. As shown in chart 134-1, a recorded haptic feedback at P1 122, as indicated by line 136A-1, is within a predefined limit of a nominal haptic feedback, as indicated by line 133A-1. Chart 134-1 also shows recorded haptic feedback at P2 124, as indicated by line 136B-1, is exceeding a predefined limit of a nominal haptic feedback, as indicated by line 133B-1, and recorded haptic feedback at P3 126, as indicated by line 136C-1, is not exceeding a predefined limit of a nominal haptic feedback, as indicated by line 133C-1.

FIG. 1B shows that at a later point in time, t2, that after determining that one or more of the determined fit characteristics of each of P1 122, P2 124, and/or P3 126 deviate from a nominal fit characteristic, the fit of the wearable-glove device 104 and/or one or more characteristics of applying the haptic feedback can be adjusted. For example, FIG. 1B shows in cut-away view 112 that inflatable/defaultable portion 120B inflates to move the haptic feedback generator 116B in better contact with the middle phalanx 124 of the user 100, and inflatable/defaultable portion 120C deflates to move the haptic feedback generator 116C in better contact with the proximal phalanx 126 of the user 100.

As shown here in chart 128-2, which is a continuation of chart 128-1 at a later time, t2, the plurality of determined fit characteristic lines (131A-2, 131B-2, and 131C-2) each corresponding to a determined fit characteristic 130A-2, 130B-2, and 130C-2 of each of P1 122, P2 124, and P3 126 over time now no longer deviate from their respective nominal fit characteristic lines 132A-2, 132B-2, and 132C-2, which are the same nominal fit characteristic lines shown in FIG. 1A.

Accordingly, chart 134-2 now shows that recorded haptic feedback at P1 122, as indicated by line 136A-2, is within a predefined limit of a nominal haptic feedback, as indicated by its close proximity to nominal haptic feedback line 133A-2. Chart 134-2 also shows recorded haptic feedback at P2 124, as indicated by line 136B-2, is within a predefined limit of a nominal haptic feedback 133B-2, and recorded haptic feedback at P3 126, as indicated by line 136C-2, is within a predefined limit of a nominal haptic feedback 133C-2.

FIG. 1C shows at a later point in time, t3, that fit characteristics of the wearable-glove device 104 are continually monitored and can be updated based on movement and orientation of the wearable-glove device 104. As hand orientation changes, the fit characteristics and resulting haptic feedback may need to be adjusted to continue to produce a convincing artificial reality.

For example, as shown in user interface 106-3 of FIG. 1C the user's wrist 144 of the user 100 rotates while still holding the artificial-reality rock 108, and in response to the orientation change the nominal fit characteristic and/or the nominal haptic feedback changes. In some embodiments, the wrist 145 shown in the user interface 106-3 can be a virtual representation of the user's actual wrist (i.e., when in a virtual reality) or be the actual wrist of the user (i.e., when in an augmented reality).

As shown in cut-away view 112 in FIG. 1C determined fit characteristic 130B-3 and 130C-3 no longer have a respective nominal fit characteristic, as indicated by the “X” marks shown. To further illustrate this, chart 128-3 now shows new nominal fit characteristics (i.e., 132A-3, 132B-3, and 132C-3 as a result of the changed orientation of the wearable-glove device 104.

As shown in chart 128-3, a determined fit characteristic of P1 122 is still within a predefined limit of a nominal fit characteristic despite the wrist movement, as indicated by line 131A-3 proximity to nominal haptic feedback line 132A-3. Chart 128-3 further illustrates that a determined fit characteristic of P2 130B-3 is not within a predefined limit of a nominal characteristic, as indicated by line 131B-3 not being within proximity to nominal fit characteristics line 132B-3. Chart 128-3 further illustrates that a determined fit characteristic of P3 130C-3 is not within a predefined limit of a nominal fit characteristics, as indicated by line 131C-3 not being within proximity to nominal fit characteristics line 132C-3.

Accordingly, chart 134-3 now shows that recorded haptic feedback at P1 122, as indicated by line 136A-3, is still within a predefined limit of a nominal haptic feedback, as indicated by its close proximity to nominal haptic feedback line 133A-3. Chart 134-3 also shows recorded haptic feedback at P2 124, as indicated by line 136B-3, is not within a predefined limit of a nominal haptic feedback 133B-3, and recorded haptic feedback at P3 126, as indicated by line 136C-3, is within a predefined limit of a nominal haptic feedback 133C-3.

FIG. 1D shows that at a later point in time, t4, that after determining that one or more of the determined fit characteristics of each of P1 122, P2 124, and/or P3 126 deviate from a nominal fit characteristic, the fit of the wearable-glove device 104 and/or one or more characteristics of applying the haptic feedback can be adjusted. For example, FIG. 1D shows in cut-away view 112 that inflatable/defaultable portion 120B inflates to move the haptic feedback generator 116B in better contact with the middle phalanx 124 of the user 100, and inflatable/defaultable portion 120C deflates to move the haptic feedback generator 116C in better contact with the proximal phalanx 126 of the user 100.

As shown here in chart 128-4, which is a continuation of chart 128-3 at a later time, the plurality of determined fit characteristic lines (131A-4, 131B-4, and 131C-4) each corresponding to a determined fit characteristic 130A-4, 130B-4, and 130C-4 of each of P1 122, P2 124, and P3 126 over time now no longer deviate from their respective nominal fit characteristic lines 132A-4, 132B-4, and 132C-4.

Accordingly, chart 134-4 now shows that recorded haptic feedback at P1 122, as indicated by line 136A-4, is within a predefined limit of a nominal haptic feedback, as indicated by its close proximity to nominal haptic feedback line 133A-4. Chart 134-4 also shows recorded haptic feedback at P2 124, as indicated by line 136B-4, is within a predefined limit of a nominal haptic feedback 133B-4, and recorded haptic feedback at P3 126, as indicated by line 136C-4, is within a predefined limit of a nominal haptic feedback 133C-4.

FIG. 1E illustrates the user 100 now interacting with a different type of artificial reality as illustrated by user interface 106-5, which shows user 100 now interacting with an artificial reality with an artificial-reality water and an artificial-reality wind blowing (i.e., a different artificial reality environment than that described in reference to FIGS. 1A-1D). In particular, FIG. 1E shows the wearable-glove device 104 at a fifth point in time, t5, interacting with an artificial wind, as illustrated by wind lines 140, with their hand. In this example, the determined fit characteristics of P1 130A-5, P2 130B-5, and P3 130C-5 are within the predefined limit of the nominal fit characteristics, as illustrated by chart 128-5, and chart 134-5 shows that a nominal haptic feedback is being applied to each of P1 122, P2 124, and P3 126.

FIG. 1F illustrates, at a later point in time, t6, the user 100 is now interacting with artificial-reality water 142 displayed in the artificial reality (e.g., dipping the virtually displayed hand 105 in the artificial reality water 142), as shown in user interface 106-6. FIG. 1F also illustrates that the nominal fit characteristic can change based on the object/environment they are interacting with, in addition to changing orientation.

This change is shown in cut-away view 112, which shows the determined fit characteristics of P1 130A-6 is within a predefined limit of nominal fit characteristics (e.g., fitting well for this interaction), but the determined fit characteristics of P2 130B-6 and the determined fit characteristics of P3 130C-6 are not within the predefined limit of the nominal characteristics (e.g., not fitting well for this interaction).

Chart 128-6 shows a determined fit characteristic of P1 130A-6 is still within a predefined limit of a nominal fit characteristic despite the wrist movement, as indicated by line's 131A-6 proximity to nominal haptic feedback line 132A-6. Chart 128-6 further illustrates that a determined fit characteristic of P2 130B-6 is not within a predefined limit of a nominal characteristic, as indicated by line 131B-6 not being within proximity to nominal fit characteristics line 132B-6. Chart 128-6 further illustrates that a determined fit characteristic of P3 130C-6 is not within a predefined limit of a nominal fit characteristics, as indicated by line 131C-6 not being within proximity to nominal fit characteristics line 132C-6.

Accordingly, chart 134-6 now shows that recorded haptic feedback at P1 122, as indicated by line 136A-6, is still within a predefined limit of a nominal haptic feedback, as indicated by its close proximity to nominal haptic feedback line 133A-6. Chart 134-6 also shows recorded haptic feedback at P2 124, as indicated by line 136B-6, is not within a predefined limit of a nominal haptic feedback 133B-6, and recorded haptic feedback at P3 126, as indicated by line 136C-6, is within a predefined limit of a nominal haptic feedback 133C-6.

FIG. 1G shows that at a later point in time, t7, that after determining that one or more of the determined fit characteristics 130A-7, 130B-7, and 130C-7 of each of P1 122, P2 124, and/or P3 126, respectively, deviate from a nominal fit characteristic, the fit of the wearable-glove device 104 and/or one or more characteristics of applying the haptic feedback can be adjusted. For example, FIG. 1G shows in cut-away view 112 that inflatable/defaultable portion 120B inflates to move the haptic feedback generator 116B in better contact with the middle phalanx 124 of the user 100, and inflatable/defaultable portion 120C deflates to move the haptic feedback generator 116C in better contact with the proximal phalanx 126 of the user 100.

As shown here in chart 128-7, which is a continuation of chart 128-6 at a later time, the plurality of determined fit characteristic lines (131A-7, 131B-7, and 131C-7) each corresponding to a determined fit characteristic 130A-7, 130B-7, and 130C-7 of each of P1 122, P2 124, and P3 126 over time now no longer deviate from their respective nominal fit characteristic lines 132A-7, 132B-7, and 132C-7.

Accordingly, chart 134-7 now shows that recorded haptic feedback at P1 122, as indicated by line 136A-7, is within a predefined limit of a nominal haptic feedback, as indicated by its close proximity to nominal haptic feedback line 133A-7. Chart 134-7 also shows recorded haptic feedback at P2 124, as indicated by line 136B-7, is within a predefined limit of a nominal haptic feedback 133B-7, and recorded haptic feedback at P3 126, as indicated by line 136C-7, is within a predefined limit of a nominal haptic feedback 133C-7.

FIG. 1H illustrates no haptic feedback response being provided to the user 100 as the user 100 is not interacting with anything in the artificial-reality environment, as illustrated in user interface 106-8. Since there is no interaction with the artificial-reality environment, there is no need to provide a haptic feedback to the user 100, and therefore no fit characteristics need to be measured to ensure the haptic feedback is being applied properly. Measuring fit characteristics selectively improves battery life of the artificial reality-headset 102 thereby improving how long the user 100 can interact with the artificial environment, i.e., making the experience more immersive. FIG. 1H further illustrates this lack of determination in chart 128-8, which shows that no fit characteristics are being determined and no nominal fit characteristics are provided. Chart 134-8 also shows that there is no haptic feedback provided to the user.

FIG. 1I illustrates another user 148 wearing the wearable-glove device 104 (i.e., the same wearable-glove device 104 that user 100 was also wearing), and the other user 148 having a different sized hand than the user 100 (e.g., smaller or larger). The other user 148 is interacting with an artificial-reality rock 108, as illustrated in in user interface 150-1. In some embodiments, the artificial-reality rock 108 is the same artificial-reality rock that user 100 interacted with. FIG. 1I further illustrates the other user 148 wearing a virtual-reality headset 102 while interacting with the artificial-reality rock 108.

FIG. 1I generally illustrates that the wearable-glove device 104 is configured to accommodate multiple users with varying hand size including the length/width of their fingers. This is done by tailoring the haptic feedback and other fit characteristics to each individual user of the wearable-glove device 104 using the methods described above.

As shown in cut-away view 152 in FIG. 1I determined fit characteristic 154B-1 and 154C-3 do not have a respective nominal fit characteristic, as indicated by the “X” marks shown. FIG. 1I shows another distal phalanx 160 (hereinafter also referred to as “AP1 160”), another middle phalanx 162 (hereinafter also referred to as “AP2 162”), and another proximal phalanx 164 (hereinafter also referred to as “AP3 164”) associated with a finger 166 of the other user 148.

As shown in chart 156-1, a determined fit characteristic of AP2 162 is within a predefined limit of a nominal fit characteristic, as indicated by line 168B-1 proximity to nominal haptic feedback line 170B-1. Chart 156-1 further illustrates that a determined fit characteristic of AP1 160 is not within a predefined limit of a nominal characteristic, as indicated by line 168A-1 not being within proximity to nominal fit characteristics line 170A-1. Chart 156-1 further illustrates that a determined fit characteristic of AP3 164 is not within a predefined limit of a nominal fit characteristics, as indicated by line 168C-1 not being within proximity to nominal fit characteristics line 170C-1.

Accordingly, chart 171-1 shows that recorded haptic feedback at AP2 162, as indicated by line 172B-1, is still within a predefined limit of a nominal haptic feedback, as indicated by its close proximity to nominal haptic feedback line 174B-1. Chart 171-1 shows recorded haptic feedback at AP1 160, as indicated by line 172A-1, is not within a predefined limit of a nominal haptic feedback 174A-1, and recorded haptic feedback at AP3 164, as indicated by line 172C-1, is within a predefined limit of a nominal haptic feedback 174C-1.

FIG. 1J illustrates a later point in time, t2, that after determining that one or more of the determined fit characteristics of each of 154A-1, 154B-1, and 154C-1 deviate from a nominal fit characteristic, the fit of the wearable-glove device 104 and/or one or more characteristics of applying the haptic feedback can be adjusted. The one or more fit characteristics of each of 154A-1, 154B-1, and 154C-1 are adjusted to optimize the fit of the wearable-glove device 104 for the other user such that the fit characteristics are within a predefined limit of a nominal fit characteristic.

FIG. 1I shows that at a later point in time, t2, that after determining that one or more of the determined fit characteristics of each of AP1 160, AP2 162, and/or AP3 164 deviate from a nominal fit characteristic, the fit of the wearable-glove device 104 and/or one or more characteristics of applying the haptic feedback can be adjusted. For example, FIG. 1I shows in cut-away view 152 that inflatable/defaultable portion 120A inflates to move the haptic feedback generator 116A in better contact with the middle phalanx 162 of the user 148, and inflatable/defaultable portion 120C deflates to move the haptic feedback generator 116C in better contact with the proximal phalanx 164 of the user 148.

As shown here in chart 156-2, which is a continuation of chart 156-1 at a later time, the plurality of determined fit characteristic lines (168A-2, 168B-2, and 168C-2) each corresponding to a determined fit characteristic 154A-2, 154B-2, and 154C-2 of each of AP1 160, AP2 162, and AP3 164 over time now no longer deviate from their respective nominal fit characteristic lines 170A-2, 170B-2, and 170C-2.

Accordingly, chart 171-2 now shows that recorded haptic feedback at AP1 160, as indicated by line 172A-2, is within a predefined limit of a nominal haptic feedback, as indicated by its close proximity to nominal haptic feedback line 174A-2. Chart 171-2 also shows recorded haptic feedback at AP2 162, as indicated by line 172B-2, is within a predefined limit of a nominal haptic feedback 174B-2, and recorded haptic feedback at AP3 164, as indicated by line 172C-2, is within a predefined limit of a nominal haptic feedback 174C-2.

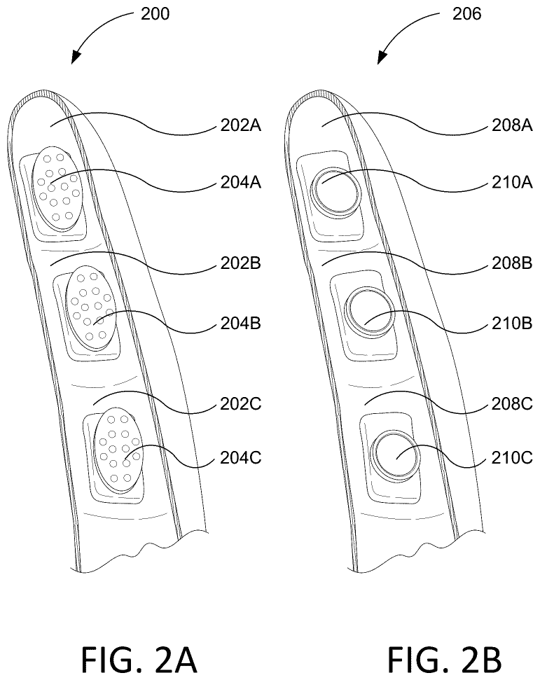

FIGS. 2A-2B illustrate two example embodiments of haptic feedback generators that are configured to provide a haptic feedback to a user, in accordance with some embodiments. FIG. 2A illustrates a finger sheath 200 of a wearable-glove device that includes a pneumatic/hydraulic haptic feedback generator for applying haptic feedback to a user. FIG. 2A shows that each phalanx 202A-202C includes a pneumatic/hydraulic haptic feedback generator 204A-204C. In some embodiments, pneumatic/hydraulic haptic feedback generator 204A-204C is continuous across all the phalanges 202A-202C. In some embodiments, the pneumatic/hydraulic haptic feedback generator 204A-204C is only at locations that correspond to locations on a finger that have the most nerve endings. In some embodiments, the joints do not have pneumatic/hydraulic haptic feedback generator 204A-204C over them to increase mobility of digits of a user.

FIG. 2B illustrates a finger sheath 206 of a wearable-glove device that includes an electrical/mechanical based haptic feedback generator for applying haptic feedback to a user. FIG. 2B shows that each phalanx 208A-208C includes an electrical/mechanical based haptic feedback generator 210A-210C. In some embodiments, an electrical/mechanical based haptic feedback generator 210A-210C is continuous across all the phalanges 208A-208C. In some embodiments, an electrical/mechanical based haptic feedback generator 210A-210C is only at locations that correspond to locations on a finger that have the most nerve endings. In some embodiments, the joints do not have an electrical/mechanical based haptic feedback generator 210A-210C over them to increase mobility of digits of a user. In some embodiments, the components described as being attached to finger sheath 200 and the finger sheath 206 can be attached either internally, externally and/or sewn into the sheath.

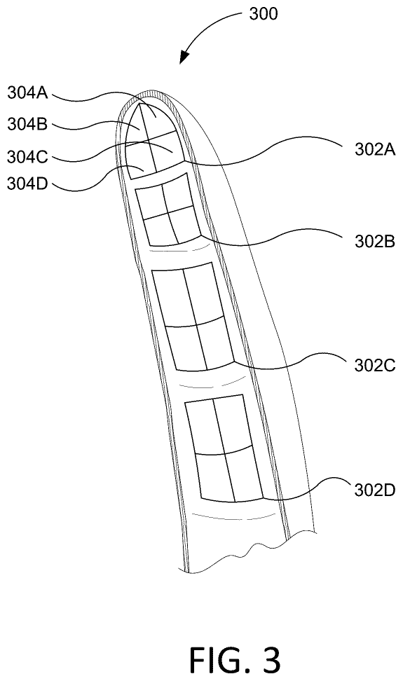

FIG. 3 illustrates an outer layer of a wearable-glove device 104 that is configured for detecting capacitive inputs at each phalanx of the finger, in accordance with some embodiments. FIG. 3 shows a finger sheath 300 of the wearable-glove device 104 that includes a plurality of capacitive sensor groups (302A-302D) located at each phalanx of a user's finger. These capacitive sensor groups, such as capacitive sensor group 302A, include bifurcated capacitive sensors sections 304A-304D that are configured to detect fine motor movements of a user's finger when contacting a surface (e.g., a user' rolling their finger on a surface (e.g., a table) can be detected). In some embodiments, the finger sheath 300 is configured to be an outer layer of the sheaths described in reference to FIGS. 2A and 2B. In some embodiments, the sensors groups 302A-202D are configured to be placed on a single sheath with the components described in reference to FIGS. 2A-2B. In some embodiments, the sensor groups are on a non-finger facing portion of the sheath and the haptic feedback generators are on a finger facing portion of the sheath.

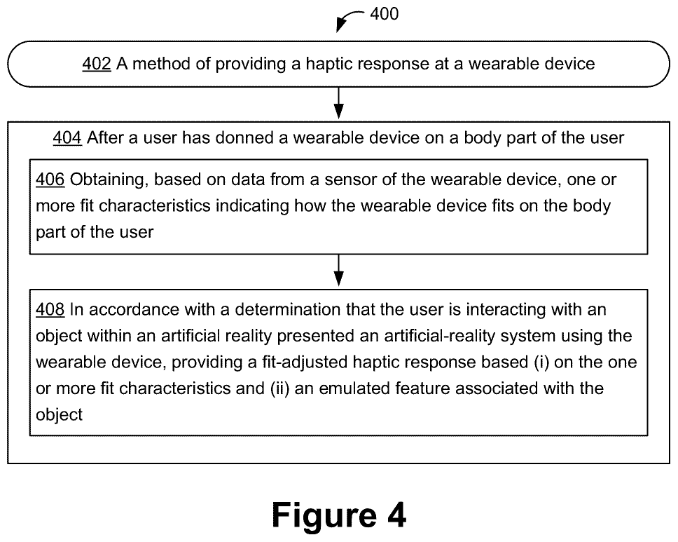

FIG. 4 shows an example method flow chart for providing a personalized haptic response, in accordance with some embodiments.
(A1) In accordance with some embodiments, a method 400 of providing a haptic response at a wearable device (402) comprises: after a user has donned a wearable device on a body part of the user (404) (e.g., FIG. 1A illustrates a user 100 wearing a wearable-glove device 104), obtaining (406), based on data from a sensor of the wearable device, one or more fit characteristics indicating how the wearable device fits on the body part of the user (e.g., FIG. 1A shows that each portion (i.e., a distal phalanx 122, a middle phalanx 124, and a proximal phalanx 126) of a user's finger 114 has its own respective determined fit characteristic 130A-1, 130B-1, and 130C-1, respectively, and the determined fit characteristics are determined via at least a sensor 171 and/or 118A-118C). After a user has donned a wearable device on a body part of the user, in accordance with a determination that the user is interacting with an object within an artificial reality presented an artificial-reality system using the wearable device (e.g., FIG. 1A-1B shows user 100 interacting with artificial-reality rock 108 displayed at artificial reality-headset 102), providing (408) a fit-adjusted haptic response based (i) on the one or more fit characteristics and (ii) an emulated feature associated with the object (e.g., comparing charts 128-1 and 134-1 in FIG. 1A to charts 128-2 and 134-2 FIG. 1B, the determined fit characteristics and resulting haptic feedback at middle phalanx (“P2”) 124 and proximal phalanx (“P3”) 126 have been adjusted to provide a haptic response that is tailored to the user 100).
(A2) In some embodiments of A1, the wearable device is configured in accordance with any of B1-B18.
(B1) In accordance with some embodiments, a non-transitory computer-readable storage medium that includes instructions that, when executed by an artificial-reality system that includes a wearable device (e.g., a glove, a wrist-worn wearable device, head-worn wearable device, etc.), cause the artificial-reality system to perform operations including: after a user has donned the wearable device on a body part of the user (e.g., FIG. 1A illustrates a user 100 wearing a wearable-glove device 104), obtaining, based on data from a sensor of the wearable device, one or more fit characteristics indicating how the wearable device fits on the body part of the user (e.g., FIG. 1A shows that each portion (i.e., a distal phalanx 122, a middle phalanx 124, and a proximal phalanx 126) of a user's finger 114 has its own respective determined fit characteristic 130A-1, 130B-1, and 130C-1, respectively, and the determined fit characteristics are determined via at least a sensor 171 and/or 118A-118C). The non-transitory computer-readable storage medium that includes instructions that, when executed by an artificial-reality system, also cause the artificial-reality system to perform operations that include, in accordance with a determination that the user is interacting with an object within an artificial reality presented via the artificial-reality system using the wearable device (e.g., FIG. 1A-1B shows user 100 interacting with artificial-reality rock 108 displayed at artificial-reality headset 102), providing a fit-adjusted haptic response based (i) on the one or more fit characteristics and (ii) an emulated feature associated with the object (e.g., comparing charts 128-1 and 134-1 in FIG. 1A to charts 128-2 and 134-2 FIG. 1B, the determined fit characteristics and resulting haptic feedback at middle phalanx (“P2”) 124 and proximal phalanx (“P3”) 126 have been adjusted to provide a haptic response that is tailored to the user 100).
(B2) In some embodiments of B1, wherein the instructions, when executed by the artificial-reality system, further cause the artificial-reality system to perform operations including: after a second user has donned the wearable device on a body part of the second user (e.g., FIG. 1I-1J illustrate another user 148 donning the same wearable-glove device 104): obtaining, based on data from the sensor of the wearable device, one or more second fit characteristics of the wearable device on the body part of the second user (e.g., FIG. 1I shows that each portion (i.e., a distal phalanx 160 a middle phalanx 162 and a proximal phalanx 164) of another user's finger 166 has its own respective determined fit characteristic 154A-1, 154B-1, and 154C-1, respectively, and the determined fit characteristics are determined via at least a sensor 171). In some embodiments, after a second user has donned the wearable device on a body part of the second user, in accordance with a determination that the second user is interacting with the object within an artificial reality presented via the artificial-reality system, provide an additional fit-adjusted haptic response based on the one or more second fit characteristics, wherein the additional fit-adjusted haptic response is distinct from the fit-adjusted haptic response (e.g., comparing charts 156-1 and 171-1 in FIG. 1I to charts 156-2 and 171-2 FIG. 1J, the determined fit characteristics and resulting haptic feedback at distal phalanx (“AP1”) 160 and proximal phalanx (“AP3”) 164 have been adjusted to provide a haptic response that is tailored to the other user 148, wherein the haptic response that is tailored to the user 148 is different than the haptic response that is tailored to the user 100). In other words, different wearers of the same wearable-glove device can receive different fit-adjusted haptic responses when interacting with the same object within an artificial reality, such that the ability of the wearable device to sense fit characteristics and then allow for adjustments to the haptic response such that a fit-adjusted haptic response is provided that is appropriate for the specific wearer of the wearable device.
(B3) In some embodiments of any of B1-B2, the fit-adjusted haptic response is only provided while the user is interacting with the object (e.g., FIG. 1H shows the user not interacting with an object within an artificial reality, and accordingly no fit determination is made and no fit-adjusted haptic feedback is provided).
(B4) In some embodiments of any of B1-B3, the instructions for obtaining the one or more fit characteristics include instructions for obtaining one or more zone-specific fit characteristics at each of a plurality of fit-sensing zones of the wearable device (e.g., FIG. 1A illustrates that a palmar side 103 of the wearable-glove device 104 includes a plurality of haptic feedback zones (110A-110L)). In some embodiments, the instructions for providing the fit-adjusted haptic response include instructions for providing a respective zone-specific fit-adjusted haptic response at each of selected fit-sensing zones of the plurality of fit-sensing zones of the wearable device (e.g., FIG. 1A illustrates that each zone is configured to act independently of each other, as shown by each phalange having its own respective determined fit characteristic 130A-1, 130B-1, and 130C-1). In some embodiments, the selected fit-sensing zones correspond to areas of the wearable device determined to be in simulated contact with the object when the fit-adjusted haptic response is provided. Stated more simply, the wearable device includes a plurality of zones (e.g., a glove device can include different zones for each finger or different zones for each phalanx of the user's finger), and each zone of the plurality of zones can be individually adjusted to provide a zone-specific fit-adjusted haptic responses (and individually adjusted based on zone-specific fit characteristics). When certain zones are not in contact with the object, then no haptic response needs to be provided at those certain zones in some embodiments.
(B5) In some embodiments of any of B1-B4, each respective zone-specific fit-adjusted haptic response is based on (i) one or more zone-specific fit characteristics (e.g., FIGS. 1A-1B show that each phalange has its own respective nominal haptic feedback, which is indicated in chart 134-1 as lines 133A-1, 133B-1, and 133C-1; and indicated in chart 134-2 as lines 133A-2, 133B-2, and 133C-2) and (ii) the object (e.g., artificial-reality rock 108). In other words, different zones of the wearable device can have different fit-adjusted haptic responses provided based on the specific fit characteristics of a respective fit-sensing zone at which the respective zone-specific fit-adjusted haptic response is provided.
(B6) In some embodiments of any of B1-B5, the instructions for providing the fit-adjusted haptic response include instructions for each respective zone-specific fit-adjusted haptic response, include, activating two or more haptic feedback generating components within the respective zone of the plurality of fit-sensing zones in accordance with the respective zone-specific fit-adjusted haptic response (e.g., FIG. 2A illustrates pneumatic/hydraulic haptic feedback generator 204A that includes an array of haptic feedback generators (e.g., a plurality inflatable bubbles that can be independently activated or deactivated)).
(B7) In some embodiments of any of B1-B6, the two or more haptic feedback generating components within the respective zone of the plurality of zones are different from each other, allowing for nuanced zone-specific fit-adjusted haptic responses (e.g., a zone may provide a first fit-adjusted haptic response based on its position relative to the object and a second zone may provide a second fit-adjusted haptic response based on its different position relative to the object).
(B8) In some embodiments of any of B1-B7, the fit-adjusted haptic response is provided via a haptic-feedback generator integrated into the wearable device (e.g., FIG. 1A illustrates haptic feedback generators 116A-116C associated with each phalanx).
(B9) In some embodiments of any of B1-B8, obtaining one or more fit characteristics indicating how the wearable device fits on the body part of the user is obtained by recording data from a sensor different from a component that provides the fit-adjusted haptic response. For example, FIG. 1 shows that haptic feedback generators 116A is distinct and separate from the sensor 118A.
(B10) In some embodiments of any of B1-B9, the non-transitory computer readable storage medium of claim 9, wherein the sensor is an inertial measurement unit sensor, wherein data from the inertial measurement unit sensor can be used to determine performance of the fit-adjusted haptic response (e.g., comparing the data with a desired response for the haptic response (e.g., haptic response not powerful enough or too powerful). In some embodiments, if the haptic response is within a threshold variation of the desired haptic response, no adjustment is performed.
(B11) In some embodiments of any of B1-B10, the instructions that, when executed by the artificial-reality system, further cause the artificial-reality system to perform operations including, after a user has donned the wearable device on a body part of the user: obtaining one or more fit characteristics indicating how the wearable device fits on the body part of the user, and in accordance with a determination that the one or more fit characteristics indicate that the wearable device is properly affixed to the body part of the user, forgoing adjusting the fit-adjusted haptic response based on the one or more fit characteristics. For example, FIG. 1E illustrates that the user 100 is interacting with an artificial environment and the determined fit characteristics the determined fit characteristics of P1 130A-5, P2 130B-5, and P3 130C-5 indicate that each of them are within a predefined limit of the nominal fit characteristics, thus no adjustment is required to the haptic feedback or how the wearable-glove device 104 fits.
(B12) In some embodiments of any of B1-B11, the instructions that, when executed by the artificial-reality system, further cause the artificial-reality system to perform operations including, after providing the fit-adjusted haptic response based on the one or more fit characteristics and an emulated feature associated with the object: obtaining an additional one or more fit characteristics indicating how the wearable device fits on the body part of the user, and in accordance with a determination that the user is interacting with the object (or another different object or orientation with the same object) within the artificial reality using the wearable device, providing another fit-adjusted haptic response based on the additional one or more fit characteristics and the emulated feature associated with the object. For example, FIGS. 1C-1D illustrate that after the fit-adjusted haptic feedback shown in FIG. 1A-1, the user 100 rotates their wrist 144, and as a result, the determined fit characteristic 130B-3 and 130C-3 no longer have a respective nominal fit characteristic, as indicated by the “X” marks shown. FIG. 1D shows the wearable-glove device further adjusting to compensate for this change in orientation while interacting with the artificial-reality rock 108.
(B13) In some embodiments of any of B1-B12, the wearable device is a wearable-glove device. In some embodiments, the one or more fit characteristics indicate how the wearable device fits on the body part of the user is obtained via an inertial measurement unit (IMU) located on different parts of the glove wearable device (e.g., on each digit or on each phalanx of each finger). In some embodiments, the fit-adjusted haptic response is provided by a haptic feedback generator, where the haptic feedback generator is configured to alter its feedback or change its shape. For example, the sensors 118A-118C and sensor 171 in FIG. 1A can be configured to be IMU sensors.
(B14) In some embodiments of any of B1-B13, the wearable-glove device includes a bladder that is configured to expand and contract and causes the haptic feedback generator to move closer or away from the body part of the user. FIGS. 1A-1B illustrate that in the cut-away view 112 that an inflatable/defaultable portion (e.g., pneumatically inflatable/defaultable, hydraulically inflatable/defaultable, mechanically tightening/loosing) 120A-120C is configured to loosen or tighten the wearable-glove device 104 (and the respective haptic feedback generator) about each phalange.
(B15) In some embodiments of any of B1-B14, the wearable-glove device includes a bifurcated finger-tip sensor configured to detect forces acting on a tip of the user's finger (e.g., to determine position of the user's finger (e.g., pitch, roll, and yaw of the fingertip)). For example, FIG. 3 illustrates a capacitive sensor group 302A that includes bifurcated capacitive sensors sections 304A-304D that are configured to detect fine motor movements of a user's finger when contacting a surface (e.g., a user' rolling their finger on a surface (e.g., a table) can be detected).
(B16) In some embodiments of any of B1-B15, The non-transitory computer readable storage medium of claim 1, wherein the fit-adjusted haptic response is provided via an inflatable bubble array or a vibrational motor. FIG. 2A illustrates a finger sheath 200 of a wearable-glove device that includes a pneumatic/hydraulic haptic feedback generator for applying haptic feedback to a user, and FIG. 2B illustrates a finger sheath 206 of a wearable-glove device that includes an electrical/mechanical based haptic feedback generator for applying haptic feedback to a user.
(B17) In some embodiments of any of B1-B16, the instructions that, when executed by the artificial-reality system, further cause the artificial-reality system to perform operations include, after providing the fit-adjusted haptic response based on the one or more fit characteristics and an emulated feature associated with the object: in accordance with a determination that the user is interacting with another object within the artificial reality using the wearable device, providing another fit-adjusted haptic response based on the one or more fit characteristics and an emulated feature associated with the other object. For example, FIGS. 1G-1H illustrate the user 100 interacting with different artificial reality environments and objects, and as a result the fit determinations (e.g., 130A-5, 130B-5, 130B-5 in FIG. 1E and 130A-6, 130B-6, 130B-6 in FIG. 1F) when interacting with the different objects (e.g., water) can differ and a different fit-adjusted haptic feedback can be provided.
(B18) In some embodiments of any of B1-B17, the artificial-reality system includes a head-worn wearable device configured to display the object within the artificial reality (e.g., artificial reality-headset 102 in FIG. 1A and the displayed user interface 106-1).
(B1) In accordance with some embodiments, A wearable device, comprising: one or more programs, wherein the one or more programs are stored in memory and configured to be executed by one or more processors, the one or more programs including instructions for: after a user has donned the wearable device on a body part of the user (e.g., FIG. 1A illustrates a user 100 wearing a wearable-glove device 104): obtaining, based on data from a sensor of the wearable device, one or more fit characteristics indicating how the wearable device fits on the body part of the user (e.g., FIG. 1A shows that each portion (i.e., a distal phalanx 122, a middle phalanx 124, and a proximal phalanx 126) of a user's finger 114 has its own respective determined fit characteristic 130A-1, 130B-1, and 130C-1, respectively, and the determined fit characteristics are determined via at least a sensor 171 and/or 118A-118C). After a user has donned the wearable device on a body part of the user, in accordance with a determination that the user is interacting with an object within an artificial reality presented via an artificial-reality system using the wearable device (e.g., FIG. 1A-1B shows user 100 interacting with artificial-reality rock 108 displayed at artificial-reality headset 102), providing a fit-adjusted haptic response based (i) on the one or more fit characteristics and (ii) an emulated feature associated with the object (e.g., comparing charts 128-1 and 134-1 in FIG. 1A to charts 128-2 and 134-2 FIG. 1B, the determined fit characteristics and resulting haptic feedback at middle phalanx (“P2”) 124 and proximal phalanx (“P3”) 126 have been adjusted to provide a haptic response that is tailored to the user 100).
(B2) In some embodiments of B1, the wearable device is configured in accordance with any of A1-A18.
(C1) In accordance with some embodiments, a system that includes a wearable device and an artificial-reality headset comprises, and one or more programs, wherein the one or more programs are stored in memory and configured to be executed by one or more processors. The one or more programs include instructions for, after a user has donned the wearable device on a body part of the user (e.g., FIG. 1A illustrates a user 100 wearing a wearable-glove device 104): obtaining, based on data from a sensor of the wearable device, one or more fit characteristics indicating how the wearable device fits on the body part of the user (e.g., FIG. 1A shows that each portion (i.e., a distal phalanx 122, a middle phalanx 124, and a proximal phalanx 126) of a user's finger 114 has its own respective determined fit characteristic 130A-1, 130B-1, and 130C-1, respectively, and the determined fit characteristics are determined via at least a sensor 171 and/or 118A-118C). The one or more programs also include instructions for, after a user has donned the wearable device on a body part of the user (e.g., FIG. 1A illustrates a user 100 wearing a wearable-glove device 104): in accordance with a determination that the user is interacting with an object within an artificial reality presented via the artificial-reality system using the wearable device (e.g., FIG. 1A-1B shows user 100 interacting with artificial reality rock 108 displayed at artificial-reality headset 102), providing a fit-adjusted haptic response based (i) on the one or more fit characteristics and (ii) an emulated feature associated with the object (e.g., comparing charts 128-1 and 134-1 in FIG. 1A to charts 128-2 and 134-2 FIG. 1B, the determined fit characteristics and resulting haptic feedback at middle phalanx (“P2”) 124 and proximal phalanx (“P3”) 126 have been adjusted to provide a haptic response that is tailored to the user 100).
(C2) In some embodiments of C1, the system is configured in accordance with any of B1-B18.

The devices described above are further detailed below, including wrist-wearable devices, headset devices, systems, and haptic feedback devices. Specific operations described above may occur as a result of specific hardware, such hardware is described in further detail below. The devices described below are not limiting and features on these devices can be removed or additional features can be added to these devices.

### Example Wrist-Wearable Devices

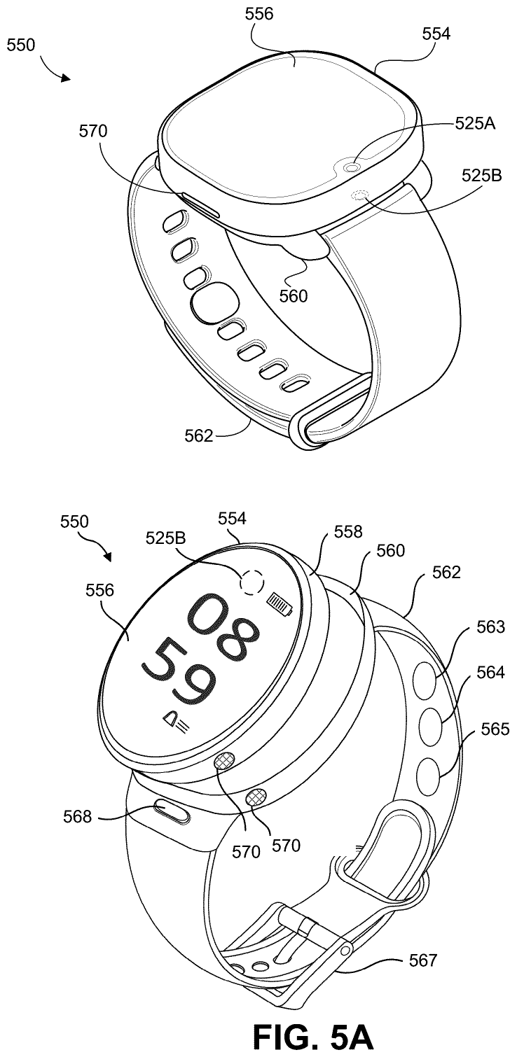

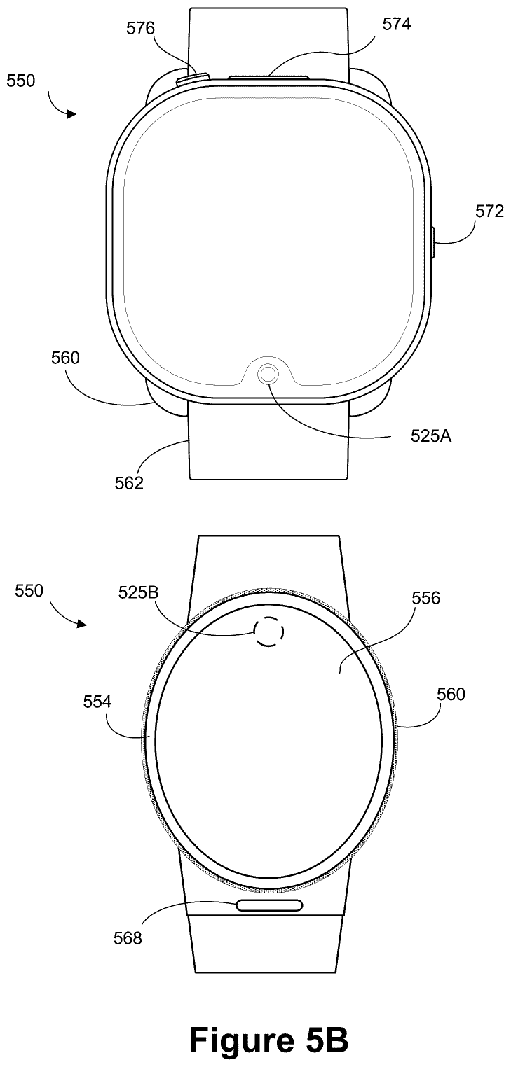

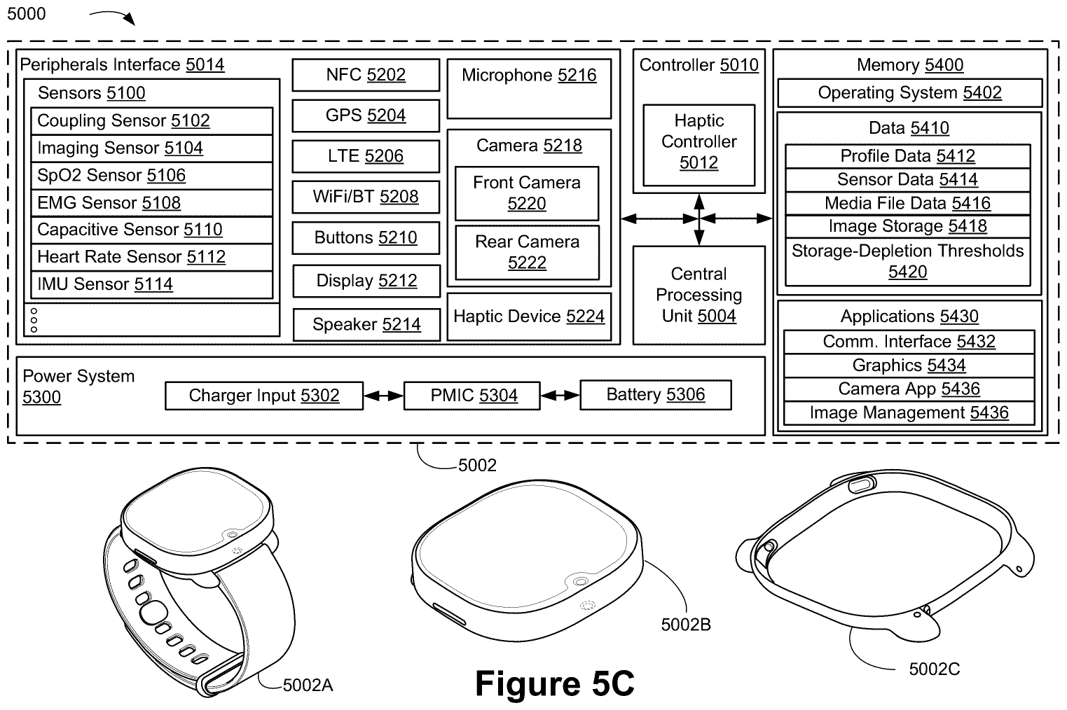

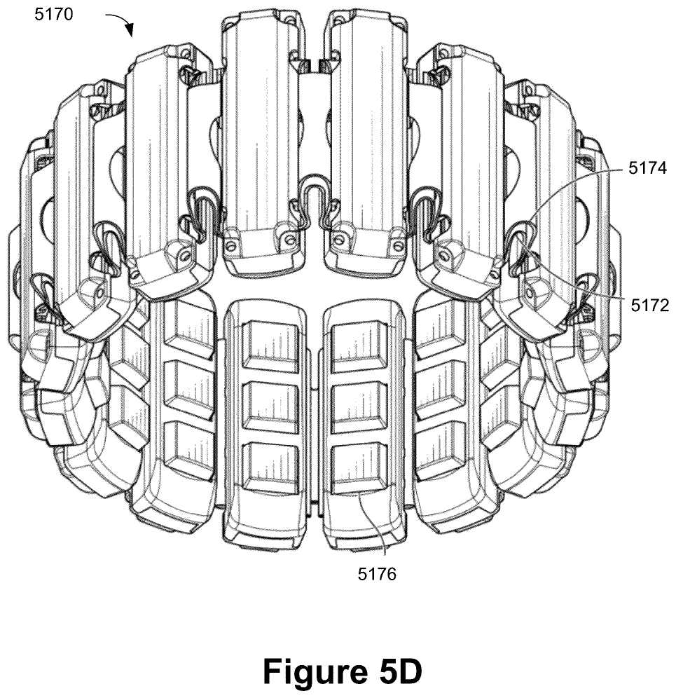

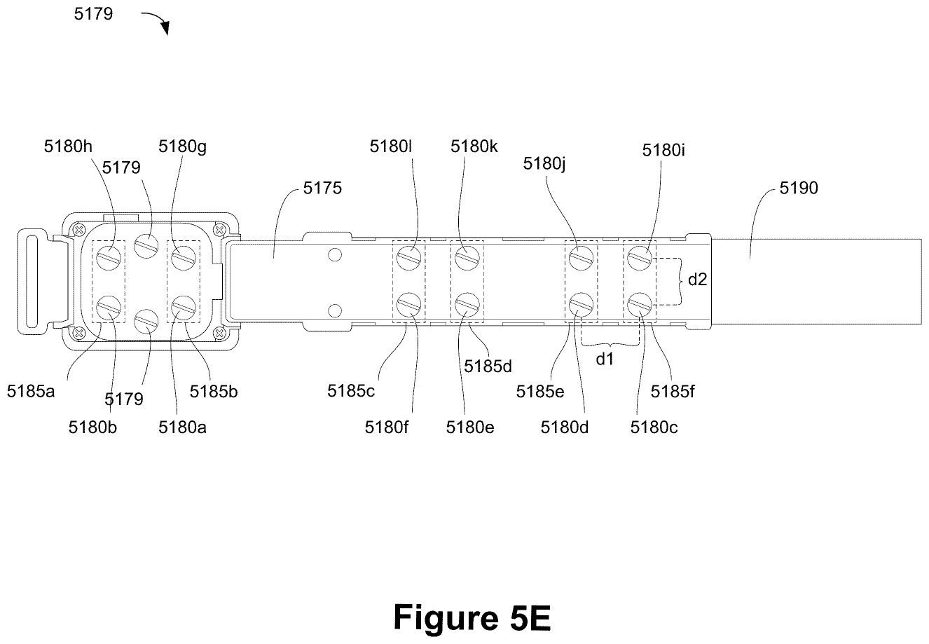

FIGS. 5A and 5B illustrate an example wrist-wearable device 550, in accordance with some embodiments. The wrist-wearable device 550 is an instance of the wearable device described herein, such that the wearable device should be understood to have the features of the wrist-wearable device 550 and vice versa. FIG. 5A illustrates a perspective view of the wrist-wearable device 550 that includes a watch body 554 coupled with a watch band 562. The watch body 554 and the watch band 562 can have a substantially rectangular or circular shape and can be configured to allow a user to wear the wrist-wearable device 550 on a body part (e.g., a wrist). The wrist-wearable device 550 can include a retaining mechanism 567 (e.g., a buckle, a hook and loop fastener, etc.) for securing the watch band 562 to the user's wrist. The wrist-wearable device 550 can also include a coupling mechanism 560 (e.g., a cradle) for detachably coupling the capsule or watch body 554 (via a coupling surface of the watch body 554) to the watch band 562.

The wrist-wearable device 550 can perform various functions associated with navigating through user interfaces and selectively opening applications. As will be described in more detail below, operations executed by the wrist-wearable device 550 can include, without limitation, display of visual content to the user (e.g., visual content displayed on display 556); sensing user input (e.g., sensing a touch on peripheral button 568, sensing biometric data on sensor 564, sensing neuromuscular signals on neuromuscular sensor 565, etc.); messaging (e.g., text, speech, video, etc.); image capture; wireless communications (e.g., cellular, near field, Wi-Fi, personal area network, etc.); location determination; financial transactions; providing haptic feedback; alarms; notifications; biometric authentication; health monitoring; sleep monitoring; etc. These functions can be executed independently in the watch body 554, independently in the watch band 562, and/or in communication between the watch body 554 and the watch band 562. In some embodiments, functions can be executed on the wrist-wearable device 550 in conjunction with an artificial-reality environment that includes, but is not limited to, virtual-reality (VR) environments (including non-immersive, semi-immersive, and fully immersive VR environments); augmented-reality environments (including marker-based augmented-reality environments, markerless augmented-reality environments, location-based augmented-reality environments, and projection-based augmented-reality environments); hybrid reality; and other types of mixed-reality environments. As the skilled artisan will appreciate upon reading the descriptions provided herein, the novel wearable devices described herein can be used with any of these types of artificial-reality environments.

The watch band 562 can be configured to be worn by a user such that an inner surface of the watch band 562 is in contact with the user's skin. When worn by a user, sensor 564 is in contact with the user's skin. The sensor 564 can be a biosensor that senses a user's heart rate, saturated oxygen level, temperature, sweat level, muscle intentions, or a combination thereof. The watch band 562 can include multiple sensors 564 that can be distributed on an inside and/or an outside surface of the watch band 562. Additionally, or alternatively, the watch body 554 can include sensors that are the same or different than those of the watch band 562 (or the watch band 562 can include no sensors at all in some embodiments). For example, multiple sensors can be distributed on an inside and/or an outside surface of the watch body 554. As described below with reference to FIGS. 5B and/or 5C, the watch body 554 can include, without limitation, a front-facing image sensor 525A and/or a rear-facing image sensor 525B, a biometric sensor, an IMU, a heart rate sensor, a saturated oxygen sensor, a neuromuscular sensor(s), an altimeter sensor, a temperature sensor, a bioimpedance sensor, a pedometer sensor, an optical sensor (e.g., imaging sensor 5104), a touch sensor, a sweat sensor, etc. The sensor 564 can also include a sensor that provides data about a user's environment including a user's motion (e.g., an IMU), altitude, location, orientation, gait, or a combination thereof. The sensor 564 can also include a light sensor (e.g., an infrared light sensor, a visible light sensor) that is configured to track a position and/or motion of the watch body 554 and/or the watch band 562. The watch band 562 can transmit the data acquired by sensor 564 to the watch body 554 using a wired communication method (e.g., a Universal Asynchronous Receiver/Transmitter (UART), a USB transceiver, etc.) and/or a wireless communication method (e.g., near field communication, Bluetooth, etc.). The watch band 562 can be configured to operate (e.g., to collect data using sensor 564) independent of whether the watch body 554 is coupled to or decoupled from watch band 562.

In some examples, the watch band 562 can include a neuromuscular sensor 565 (e.g., an EMG sensor, a mechanomyogram (MMG) sensor, a sonomyography (SMG) sensor, etc.). Neuromuscular sensor 565 can sense a user's intention to perform certain motor actions. The sensed muscle intention can be used to control certain user interfaces displayed on the display 556 of the wrist-wearable device 550 and/or can be transmitted to a device responsible for rendering an artificial-reality environment (e.g., a head-mounted display) to perform an action in an associated artificial-reality environment, such as to control the motion of a virtual device displayed to the user.

Signals from neuromuscular sensor 565 can be used to provide a user with an enhanced interaction with a physical object and/or a virtual object in an artificial-reality application generated by an artificial-reality system (e.g., user interface objects presented on the display 556, or another computing device (e.g., a smartphone)). Signals from neuromuscular sensor 565 can be obtained (e.g., sensed and recorded) by one or more neuromuscular sensors 565 of the watch band 562. Although FIG. 5A shows one neuromuscular sensor 565, the watch band 562 can include a plurality of neuromuscular sensors 565 arranged circumferentially on an inside surface of the watch band 562 such that the plurality of neuromuscular sensors 565 contact the skin of the user. The watch band 562 can include a plurality of neuromuscular sensors 565 arranged circumferentially on an inside surface of the watch band 562. Neuromuscular sensor 565 can sense and record neuromuscular signals from the user as the user performs muscular activations (e.g., movements, gestures, etc.). The muscular activations performed by the user can include static gestures, such as placing the user's hand palm down on a table; dynamic gestures, such as grasping a physical or virtual object; and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The watch band 562 and/or watch body 554 can include a haptic device 563 (e.g., a vibratory haptic actuator) that is configured to provide haptic feedback (e.g., a cutaneous and/or kinesthetic sensation, etc.) to the user's skin. The sensors 564 and 565, and/or the haptic device 563 can be configured to operate in conjunction with multiple applications including, without limitation, health monitoring, social media, game playing, and artificial reality (e.g., the applications associated with artificial reality).

The wrist-wearable device 550 can include a coupling mechanism (also referred to as a cradle) for detachably coupling the watch body 554 to the watch band 562. A user can detach the watch body 554 from the watch band 562 in order to reduce the encumbrance of the wrist-wearable device 550 to the user. The wrist-wearable device 550 can include a coupling surface on the watch body 554 and/or coupling mechanism(s) 560 (e.g., a cradle, a tracker band, a support base, a clasp). A user can perform any type of motion to couple the watch body 554 to the watch band 562 and to decouple the watch body 554 from the watch band 562. For example, a user can twist, slide, turn, push, pull, or rotate the watch body 554 relative to the watch band 562, or a combination thereof, to attach the watch body 554 to the watch band 562 and to detach the watch body 554 from the watch band 562.

As shown in the example of FIG. 5A, the watch band coupling mechanism 560 can include a type of frame or shell that allows the watch body 554 coupling surface to be retained within the watch band coupling mechanism 560. The watch body 554 can be detachably coupled to the watch band 562 through a friction fit, magnetic coupling, a rotation-based connector, a shear-pin coupler, a retention spring, one or more magnets, a clip, a pin shaft, a hook and loop fastener, or a combination thereof. In some examples, the watch body 554 can be decoupled from the watch band 562 by actuation of the release mechanism 570. The release mechanism 570 can include, without limitation, a button, a knob, a plunger, a handle, a lever, a fastener, a clasp, a dial, a latch, or a combination thereof.

As shown in FIGS. 5A-5B, the coupling mechanism 560 can be configured to receive a coupling surface proximate to the bottom side of the watch body 554 (e.g., a side opposite to a front side of the watch body 554 where the display 556 is located), such that a user can push the watch body 554 downward into the coupling mechanism 560 to attach the watch body 554 to the coupling mechanism 560. In some embodiments, the coupling mechanism 560 can be configured to receive a top side of the watch body 554 (e.g., a side proximate to the front side of the watch body 554 where the display 556 is located) that is pushed upward into the cradle, as opposed to being pushed downward into the coupling mechanism 560. In some embodiments, the coupling mechanism 560 is an integrated component of the watch band 562 such that the watch band 562 and the coupling mechanism 560 are a single unitary structure.

The wrist-wearable device 550 can include a single release mechanism 570 or multiple release mechanisms 570 (e.g., two release mechanisms 570 positioned on opposing sides of the wrist-wearable device 550 such as spring-loaded buttons). As shown in FIG. 5A, the release mechanism 570 can be positioned on the watch body 554 and/or the watch band coupling mechanism 560. Although FIG. 5A shows release mechanism 570 positioned at a corner of watch body 554 and at a corner of watch band coupling mechanism 560, the release mechanism 570 can be positioned anywhere on watch body 554 and/or watch band coupling mechanism 560 that is convenient for a user of wrist-wearable device 550 to actuate. A user of the wrist-wearable device 550 can actuate the release mechanism 570 by pushing, turning, lifting, depressing, shifting, or performing other actions on the release mechanism 570. Actuation of the release mechanism 570 can release (e.g., decouple) the watch body 554 from the watch band coupling mechanism 560 and the watch band 562 allowing the user to use the watch body 554 independently from watch band 562. For example, decoupling the watch body 554 from the watch band 562 can allow the user to capture images using rear-facing image sensor 525B.

FIG. 5B includes top views of examples of the wrist-wearable device 550. The examples of the wrist-wearable device 550 shown in FIGS. 5A-5B can include a coupling mechanism 560 (as shown in FIG. 5B, the shape of the coupling mechanism can correspond to the shape of the watch body 554 of the wrist-wearable device 550). The watch body 554 can be detachably coupled to the coupling mechanism 560 through a friction fit, magnetic coupling, a rotation-based connector, a shear-pin coupler, a retention spring, one or more magnets, a clip, a pin shaft, a hook and loop fastener, or any combination thereof.

In some examples, the watch body 554 can be decoupled from the coupling mechanism 560 by actuation of a release mechanism 570. The release mechanism 570 can include, without limitation, a button, a knob, a plunger, a handle, a lever, a fastener, a clasp, a dial, a latch, or a combination thereof. In some examples, the wristband system functions can be executed independently in the watch body 554, independently in the coupling mechanism 560, and/or in communication between the watch body 554 and the coupling mechanism 560. The coupling mechanism 560 can be configured to operate independently (e.g., execute functions independently) from watch body 554. Additionally, or alternatively, the watch body 554 can be configured to operate independently (e.g., execute functions independently) from the coupling mechanism 560. As described below with reference to the block diagram of FIG. 5A, the coupling mechanism 560 and/or the watch body 554 can each include the independent resources required to independently execute functions. For example, the coupling mechanism 560 and/or the watch body 554 can each include a power source (e.g., a battery), a memory, data storage, a processor (e.g., a central processing unit (CPU)), communications, a light source, and/or input/output devices.

The wrist-wearable device 550 can have various peripheral buttons 572, 574, and 576, for performing various operations at the wrist-wearable device 550. Also, various sensors, including one or both of the sensors 564 and 565, can be located on the bottom of the watch body 554, and can optionally be used even when the watch body 554 is detached from the watch band 562.

FIG. 5C is a block diagram of a computing system 5000, according to at least one embodiment of the present disclosure. The computing system 5000 includes an electronic device 5002, which can be, for example, a wrist-wearable device. The wrist-wearable device 550 described in detail above with respect to FIGS. 5A-5B is an example of the electronic device 5002, so the electronic device 5002 will be understood to include the components shown and described below for the computing system 5000. In some embodiments, all, or a substantial portion of the components of the computing system 5000 are included in a single integrated circuit. In some embodiments, the computing system 5000 can have a split architecture (e.g., a split mechanical architecture, a split electrical architecture) between a watch body (e.g., a watch body 554 in FIGS. 5A-5B) and a watch band (e.g., a watch band 562 in FIGS. 5A-5B). The electronic device 5002 can include a processor (e.g., a central processing unit 5004), a controller 5010, a peripherals interface 5014 that includes one or more sensors 5100 and various peripheral devices, a power source (e.g., a power system 5300), and memory (e.g., a memory 5400) that includes an operating system (e.g., an operating system 5402), data (e.g., data 5410), and one or more applications (e.g., applications 5430).

In some embodiments, the computing system 5000 includes the power system 5300 which includes a charger input 5302, a power-management integrated circuit (PMIC) 5304, and a battery 5306.

In some embodiments, a watch body and a watch band can each be electronic devices 5002 that each have respective batteries (e.g., battery 5306), and can share power with each other. The watch body and the watch band can receive a charge using a variety of techniques. In some embodiments, the watch body and the watch band can use a wired charging assembly (e.g., power cords) to receive the charge. Alternatively, or in addition, the watch body and/or the watch band can be configured for wireless charging. For example, a portable charging device can be designed to mate with a portion of watch body and/or watch band and wirelessly deliver usable power to a battery of watch body and/or watch band.

The watch body and the watch band can have independent power systems 5300 to enable each to operate independently. The watch body and watch band can also share power (e.g., one can charge the other) via respective PMICs 5304 that can share power over power and ground conductors and/or over wireless charging antennas.

In some embodiments, the peripherals interface 5014 can include one or more sensors 5100. The sensors 5100 can include a coupling sensor 5102 for detecting when the electronic device 5002 is coupled with another electronic device 5002 (e.g., a watch body can detect when it is coupled to a watch band, and vice versa). The sensors 5100 can include imaging sensors 5104 for collecting imaging data, which can optionally be the same device as one or more of the cameras 5218. In some embodiments, the imaging sensors 5104 can be separate from the cameras 5218. In some embodiments the sensors include an SpO2 sensor 5106. In some embodiments, the sensors 5100 include an EMG sensor 5108 for detecting, for example muscular movements by a user of the electronic device 5002. In some embodiments, the sensors 5100 include a capacitive sensor 5110 for detecting changes in potential of a portion of a user's body. In some embodiments, the sensors 5100 include a heart rate sensor 5112. In some embodiments, the sensors 5100 include an inertial measurement unit (IMU) sensor 5114 for detecting, for example, changes in acceleration of the user's hand.

In some embodiments, the peripherals interface 5014 includes a near-field communication (NFC) component 5202, a global-position system (GPS) component 5204, a long-term evolution (LTE) component 5206, and or a Wi-Fi or Bluetooth communication component 5208.

In some embodiments, the peripherals interface includes one or more buttons (e.g., the peripheral buttons 557, 558, and 559 in FIG. 5B), which, when selected by a user, cause operation to be performed at the electronic device 5002.

The electronic device 5002 can include at least one display 5212, for displaying visual affordances to the user, including user-interface elements and/or three-dimensional virtual objects. The display can also include a touch screen for inputting user inputs, such as touch gestures, swipe gestures, and the like.

The electronic device 5002 can include at least one speaker 5214 and at least one microphone 5216 for providing audio signals to the user and receiving audio input from the user. The user can provide user inputs through the microphone 5216 and can also receive audio output from the speaker 5214 as part of a haptic event provided by the haptic controller 5012.

The electronic device 5002 can include at least one camera 5218, including a front camera 5220 and a rear camera 5222. In some embodiments, the electronic device 5002 can be a head-wearable device, and one of the cameras 5218 can be integrated with a lens assembly of the head-wearable device.

One or more of the electronic devices 5002 can include one or more haptic controllers 5012 and associated componentry for providing haptic events at one or more of the electronic devices 5002 (e.g., a vibrating sensation or audio output in response to an event at the electronic device 5002). The haptic controllers 5012 can communicate with one or more electroacoustic devices, including a speaker of the one or more speakers 5214 and/or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). The haptic controller 5012 can provide haptic events to that are capable of being sensed by a user of the electronic devices 5002. In some embodiments, the one or more haptic controllers 5012 can receive input signals from an application of the applications 5430.

Memory 5400 optionally includes high-speed random-access memory and optionally also includes non-volatile memory, such as one or more magnetic disk storage devices, flash memory devices, or other non-volatile solid-state memory devices. Access to the memory 5400 by other components of the electronic device 5002, such as the one or more processors of the central processing unit 5004, and the peripherals interface 5014 is optionally controlled by a memory controller of the controllers 5010.

In some embodiments, software components stored in the memory 5400 can include one or more operating systems 5402 (e.g., a Linux-based operating system, an Android operating system, etc.). The memory 5400 can also include data 5410, including structured data (e.g., SQL databases, MongoDB databases, GraphQL data, JSON data, etc.). The data 5410 can include profile data 5412, sensor data 5414, media file data 5414.

In some embodiments, software components stored in the memory 5400 include one or more applications 5430 configured to be perform operations at the electronic devices 5002. In some embodiments, the one or more applications 5430 include one or more communication interface modules 5432, one or more graphics modules 5434, one or more camera application modules 5436. In some embodiments, a plurality of applications 5430 can work in conjunction with one another to perform various tasks at one or more of the electronic devices 5002.

It should be appreciated that the electronic devices 5002 are only some examples of the electronic devices 5002 within the computing system 5000, and that other electronic devices 5002 that are part of the computing system 5000 can have more or fewer components than shown optionally combines two or more components, or optionally have a different configuration or arrangement of the components. The various components shown in FIG. 5C are implemented in hardware, software, firmware, or a combination thereof, including one or more signal processing and/or application-specific integrated circuits.

As illustrated by the lower portion of FIG. 5C, various individual components of a wrist-wearable device can be examples of the electronic device 5002. For example, some or all of the components shown in the electronic device 5002 can be housed or otherwise disposed in a combined watch device 5002A, or within individual components of the capsule device watch body 5002B, the cradle portion 5002C, and/or a watch band.

FIG. 5D illustrates a wearable device 5170, in accordance with some embodiments. In some embodiments, the wearable device 5170 is used to generate control information (e.g., sensed data about neuromuscular signals or instructions to perform certain commands after the data is sensed) for causing a computing device to perform one or more input commands. In some embodiments, the wearable device 5170 includes a plurality of neuromuscular sensors 5176. In some embodiments, the plurality of neuromuscular sensors 5176 includes a predetermined number of (e.g., 16) neuromuscular sensors (e.g., EMG sensors) arranged circumferentially around an elastic band 5174. The plurality of neuromuscular sensors 5176 may include any suitable number of neuromuscular sensors. In some embodiments, the number and arrangement of neuromuscular sensors 5176 depends on the particular application for which the wearable device 5170 is used. For instance, a wearable device 5170 configured as an armband, wristband, or chest-band may include a plurality of neuromuscular sensors 5176 with different number of neuromuscular sensors and different arrangement for each use case, such as medical use cases as compared to gaming or general day-to-day use cases. For example, at least 16 neuromuscular sensors 5176 may be arranged circumferentially around elastic band 5174.

In some embodiments, the elastic band 5174 is configured to be worn around a user's lower arm or wrist. The elastic band 5174 may include a flexible electronic connector 5172. In some embodiments, the flexible electronic connector 5172 interconnects separate sensors and electronic circuitry that are enclosed in one or more sensor housings. Alternatively, in some embodiments, the flexible electronic connector 5172 interconnects separate sensors and electronic circuitry that are outside of the one or more sensor housings. Each neuromuscular sensor of the plurality of neuromuscular sensors 5176 can include a skin-contacting surface that includes one or more electrodes. One or more sensors of the plurality of neuromuscular sensors 5176 can be coupled together using flexible electronics incorporated into the wearable device 5170. In some embodiments, one or more sensors of the plurality of neuromuscular sensors 5176 can be integrated into a woven fabric, wherein the fabric one or more sensors of the plurality of neuromuscular sensors 5176 are sewn into the fabric and mimic the pliability of fabric (e.g., the one or more sensors of the plurality of neuromuscular sensors 5176 can be constructed from a series woven strands of fabric). In some embodiments, the sensors are flush with the surface of the textile and are indistinguishable from the textile when worn by the user.

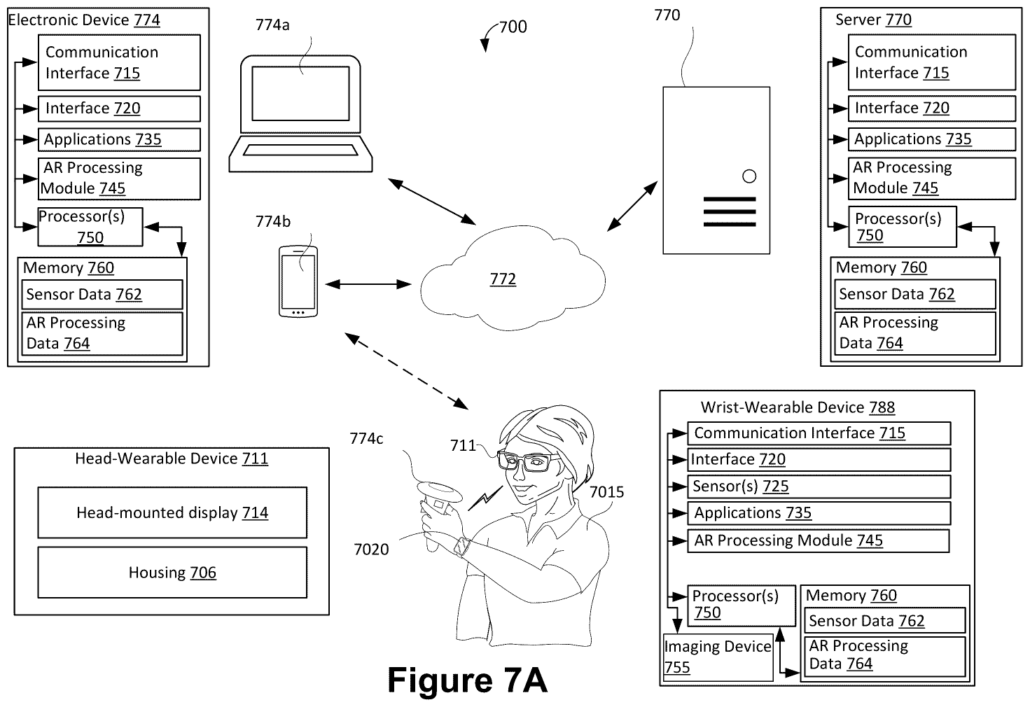

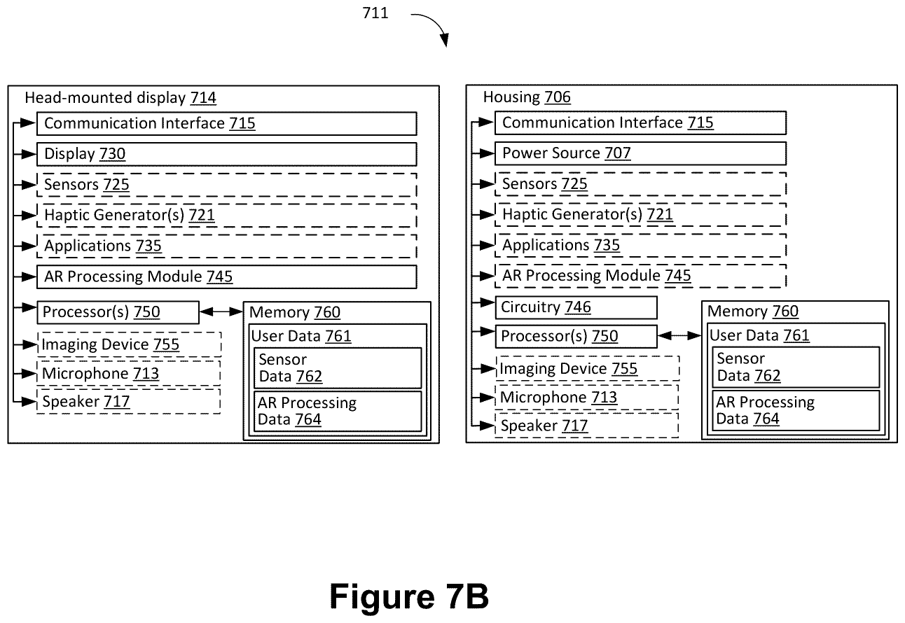

FIG. 5E illustrates a wearable device 5179 in accordance with some embodiments. The wearable device 5179 includes paired sensor channels 5185a-5185f along an interior surface of a wearable structure 5175 that are configured to detect neuromuscular signals. Different number of paired sensors channels can be used (e.g., one pair of sensors, three pairs of sensors, four pairs of sensors, or six pairs of sensors). The wearable structure 5175 can include a band portion 5190, a capsule portion 5195, and a cradle portion (not pictured) that is coupled with the band portion 5190 to allow for the capsule portion 5195 to be removably coupled with the band portion 5190. For embodiments in which the capsule portion 5195 is removable, the capsule portion 5195 can be referred to as a removable structure, such that in these embodiments the wearable device includes a wearable portion (e.g., band portion 5190 and the cradle portion) and a removable structure (the removable capsule portion which can be removed from the cradle). In some embodiments, the capsule portion 5195 includes the one or more processors and/or other components of the wearable device 788 described above in reference to FIGS. 7A and 7B. The wearable structure 5175 is configured to be worn by a user 711. More specifically, the wearable structure 5175 is configured to couple the wearable device 5179 to a wrist, arm, forearm, or other portion of the user's body. Each paired sensor channels 5185a-5185f includes two electrodes 5180 (e.g., electrodes 5180a-5180h) for sensing neuromuscular signals based on differential sensing within each respective sensor channel. In accordance with some embodiments, the wearable device 5170 further includes an electrical ground and a shielding electrode.

The techniques described above can be used with any device for sensing neuromuscular signals, including the arm-wearable devices of FIG. 5A-5C, but could also be used with other types of wearable devices for sensing neuromuscular signals (such as body-wearable or head-wearable devices that might have neuromuscular sensors closer to the brain or spinal column).

In some embodiments, a wrist-wearable device can be used in conjunction with a head-wearable device described below, and the wrist-wearable device can also be configured to be used to allow a user to control aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable device, attention will now be turned to example head-wearable devices, such AR glasses and VR headsets.

### Example Head-Wearable Devices

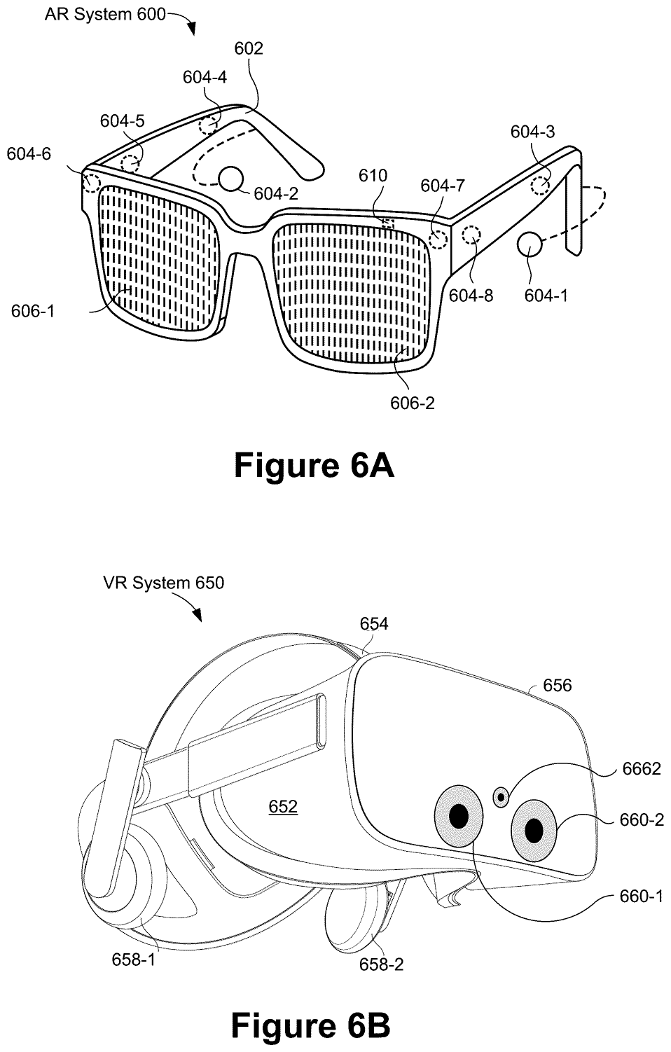

FIG. 6A shows an example AR system 600 in accordance with some embodiments. In FIG. 6A, the AR system 600 includes an eyewear device with a frame 602 configured to hold a left display device 606-1 and a right display device 606-2 in front of a user's eyes. The display devices 606-1 and 606-2 may act together or independently to present an image or series of images to a user. While the AR system 600 includes two displays, embodiments of this disclosure may be implemented in AR systems with a single near-eye display (NED) or more than two NEDs.

In some embodiments, the AR system 600 includes one or more sensors, such as the acoustic sensors 604. For example, the acoustic sensors 604 can generate measurement signals in response to motion of the AR system 600 and may be located on substantially any portion of the frame 602. Any one of the sensors may be a position sensor, an IMU, a depth camera assembly, or any combination thereof. In some embodiments, the AR system 600 includes more or fewer sensors than are shown in FIG. 6A. In embodiments in which the sensors include an IMU, the IMU may generate calibration data based on measurement signals from the sensors. Examples of the sensors include, without limitation, accelerometers, gyroscopes, magnetometers, other suitable types of sensors that detect motion, sensors used for error correction of the IMU, or some combination thereof.

In some embodiments, the AR system 600 includes a microphone array with a plurality of acoustic sensors 604-1 through 604-8, referred to collectively as the acoustic sensors 604. The acoustic sensors 604 may be transducers that detect air pressure variations induced by sound waves. In some embodiments, each acoustic sensor 604 is configured to detect sound and convert the detected sound into an electronic format (e.g., an analog or digital format). In some embodiments, the microphone array includes ten acoustic sensors: 604-1 and 604-2 designed to be placed inside a corresponding ear of the user, acoustic sensors 604-3, 604-4, 604-5, 604-6, 604-7, and 604-8 positioned at various locations on the frame 602, and acoustic sensors positioned on a corresponding neckband, where the neckband is an optional component of the system that is not present in certain embodiments of the artificial-reality systems discussed herein.

The configuration of the acoustic sensors 604 of the microphone array may vary. While the AR system 600 is shown in FIG. 6A having ten acoustic sensors 604, the number of acoustic sensors 604 may be more or fewer than ten. In some situations, using more acoustic sensors 604 increases the amount of audio information collected and/or the sensitivity and accuracy of the audio information. In contrast, in some situations, using a lower number of acoustic sensors 604 decreases the computing power required by a controller to process the collected audio information. In addition, the position of each acoustic sensor 604 of the microphone array may vary. For example, the position of an acoustic sensor 604 may include a defined position on the user, a defined coordinate on the frame 602, an orientation associated with each acoustic sensor, or some combination thereof.

The acoustic sensors 604-1 and 604-2 may be positioned on different parts of the user's ear. In some embodiments, there are additional acoustic sensors on or surrounding the ear in addition to acoustic sensors 604 inside the ear canal. In some situations, having an acoustic sensor positioned next to an ear canal of a user enables the microphone array to collect information on how sounds arrive at the ear canal. By positioning at least two of the acoustic sensors 604 on either side of a user's head (e.g., as binaural microphones), the AR device 600 is able to simulate binaural hearing and capture a 3D stereo sound field around a user's head. In some embodiments, the acoustic sensors 604-1 and 604-2 are connected to the AR system 600 via a wired connection, and in other embodiments, the acoustic sensors 604-1 and 604-2 are connected to the AR system 600 via a wireless connection (e.g., a Bluetooth connection). In some embodiments, the AR system 600 does not include the acoustic sensors 604-1 and 604-2.

The acoustic sensors 604 on the frame 602 may be positioned along the length of the temples, across the bridge of the nose, above or below the display devices 606, or in some combination thereof. The acoustic sensors 604 may be oriented such that the microphone array is able to detect sounds in a wide range of directions surrounding the user that is wearing the AR system 600. In some embodiments, a calibration process is performed during manufacturing of the AR system 600 to determine relative positioning of each acoustic sensor 604 in the microphone array.

In some embodiments, the eyewear device further includes, or is communicatively coupled to, an external device (e.g., a paired device), such as the optional neckband discussed above. In some embodiments, the optional neckband is coupled to the eyewear device via one or more connectors. The connectors may be wired or wireless connectors and may include electrical and/or non-electrical (e.g., structural) components. In some embodiments, the eyewear device and the neckband operate independently without any wired or wireless connection between them. In some embodiments, the components of the eyewear device and the neckband are located on one or more additional peripheral devices paired with the eyewear device, the neckband, or some combination thereof. Furthermore, the neckband is intended to represent any suitable type or form of paired device. Thus, the following discussion of neckband may also apply to various other paired devices, such as smart watches, smart phones, wrist bands, other wearable devices, hand-held controllers, tablet computers, or laptop computers.

In some situations, pairing external devices, such as the optional neckband, with the AR eyewear device enables the AR eyewear device to achieve the form factor of a pair of glasses while still providing sufficient battery and computation power for expanded capabilities. Some, or all, of the battery power, computational resources, and/or additional features of the AR system 600 may be provided by a paired device or shared between a paired device and an eyewear device, thus reducing the weight, heat profile, and form factor of the eyewear device overall while still retaining desired functionality. For example, the neckband may allow components that would otherwise be included on an eyewear device to be included in the neckband thereby shifting a weight load from a user's head to a user's shoulders. In some embodiments, the neckband has a larger surface area over which to diffuse and disperse heat to the ambient environment. Thus, the neckband may allow for greater battery and computation capacity than might otherwise have been possible on a stand-alone eyewear device. Because weight carried in the neckband may be less invasive to a user than weight carried in the eyewear device, a user may tolerate wearing a lighter eyewear device and carrying or wearing the paired device for greater lengths of time than the user would tolerate wearing a heavy, stand-alone eyewear device, thereby enabling an artificial-reality environment to be incorporated more fully into a user's day-to-day activities.

In some embodiments, the optional neckband is communicatively coupled with the eyewear device and/or to other devices. The other devices may provide certain functions (e.g., tracking, localizing, depth mapping, processing, storage, etc.) to the AR system 600. In some embodiments, the neckband includes a controller and a power source. In some embodiments, the acoustic sensors of the neckband are configured to detect sound and convert the detected sound into an electronic format (analog or digital).

The controller of the neckband processes information generated by the sensors on the neckband and/or the AR system 600. For example, the controller may process information from the acoustic sensors 604. For each detected sound, the controller may perform a direction of arrival (DOA) estimation to estimate a direction from which the detected sound arrived at the microphone array. As the microphone array detects sounds, the controller may populate an audio data set with the information. In embodiments in which the AR system 600 includes an IMU, the controller may compute all inertial and spatial calculations from the IMU located on the eyewear device. The connector may convey information between the eyewear device and the neckband and between the eyewear device and the controller. The information may be in the form of optical data, electrical data, wireless data, or any other transmittable data form. Moving the processing of information generated by the eyewear device to the neckband may reduce weight and heat in the eyewear device, making it more comfortable and safer for a user.

In some embodiments, the power source in the neckband provides power to the eyewear device and the neckband. The power source may include, without limitation, lithium-ion batteries, lithium-polymer batteries, primary lithium batteries, alkaline batteries, or any other form of power storage. In some embodiments, the power source is a wired power source.

As noted, some artificial-reality systems may, instead of blending an artificial reality with actual reality, substantially replace one or more of a user's sensory perceptions of the real world with a virtual experience. One example of this type of system is a head-worn display system, such as the VR system 650 in FIG. 6B, which mostly or completely covers a user's field of view.

FIG. 6B shows a VR system 650 (e.g., also referred to herein as VR headsets or VR headset) in accordance with some embodiments. The VR system 650 includes a head-mounted display (HMD) 652. The HMD 652 includes a front body 656 and a frame 654 (e.g., a strap or band) shaped to fit around a user's head. In some embodiments, the HMD 652 includes output audio transducers 658-1 and 658-2, as shown in FIG. 6B (e.g., transducers). In some embodiments, the front body 656 and/or the frame 654 includes one or more electronic elements, including one or more electronic displays, one or more IMUs, one or more tracking emitters or detectors, and/or any other suitable device or sensor for creating an artificial-reality experience.

Artificial-reality systems may include a variety of types of visual feedback mechanisms. For example, display devices in the AR system 600 and/or the VR system 650 may include one or more liquid-crystal displays (LCDs), light emitting diode (LED) displays, organic LED (OLED) displays, and/or any other suitable type of display screen. Artificial-reality systems may include a single display screen for both eyes or may provide a display screen for each eye, which may allow for additional flexibility for varifocal adjustments or for correcting a refractive error associated with the user's vision. Some artificial-reality systems also include optical subsystems having one or more lenses (e.g., conventional concave or convex lenses, Fresnel lenses, or adjustable liquid lenses) through which a user may view a display screen.

In addition to or instead of using display screens, some artificial-reality systems include one or more projection systems. For example, display devices in the AR system 600 and/or the VR system 650 may include micro-LED projectors that project light (e.g., using a waveguide) into display devices, such as clear combiner lenses that allow ambient light to pass through. The display devices may refract the projected light toward a user's pupil and may enable a user to simultaneously view both artificial-reality content and the real world. Artificial-reality systems may also be configured with any other suitable type or form of image projection system.

Artificial-reality systems may also include various types of computer vision components and subsystems. For example, the AR system 600 and/or the VR system 650 can include one or more optical sensors such as two-dimensional (2D) or three-dimensional (3D) cameras, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions. For example, FIG. 6B shows VR system 650 having cameras 660-1 and 660-2 that can be used to provide depth information for creating a voxel field and a two-dimensional mesh to provide object information to the user to avoid collisions. FIG. 6B also shows that the VR system includes one or more additional cameras 662 that are configured to augment the cameras 660-1 and 660-2 by providing more information. For example, the additional cameras 662 can be used to supply color information that is not discerned by cameras 660-1 and 660-2. In some embodiments, cameras 660-1 and 660-2 and additional cameras 662 can include an optional IR cut filter configured to remove IR light from being received at the respective camera sensors.

In some embodiments, the AR system 600 and/or the VR system 650 can include haptic (tactile) feedback systems, which may be incorporated into headwear, gloves, body suits, handheld controllers, environmental devices (e.g., chairs or floormats), and/or any other type of device or system, such as the wearable devices discussed herein. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback may be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices.

The techniques described above can be used with any device for interacting with an artificial-reality environment, including the head-wearable devices of FIG. 6A-6B, but could also be used with other types of wearable devices for sensing neuromuscular signals (such as body-wearable or head-wearable devices that might have neuromuscular sensors closer to the brain or spinal column). Having thus described example wrist-wearable device and head-wearable devices, attention will now be turned to example feedback systems that can be integrated into the devices described above or be a separate device.

### Example Feedback Devices

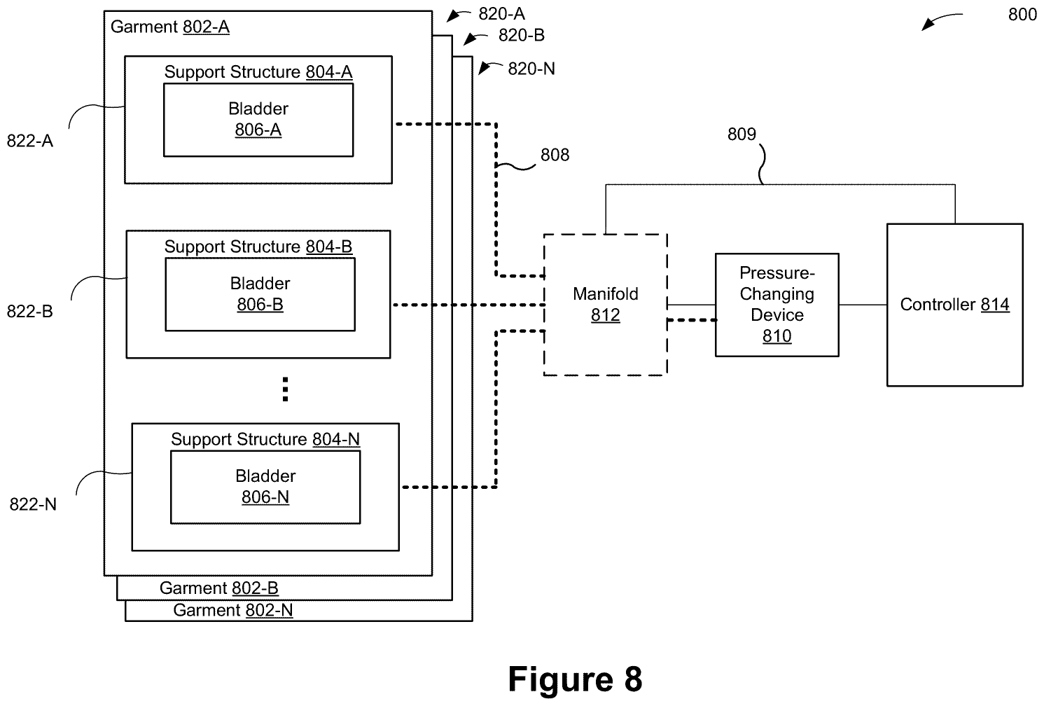

FIG. 8 is a schematic showing additional components that can be used with the artificial-reality system 700 of FIG. 7A and FIG. 7B, in accordance with some embodiments. The components in FIG. 8 are illustrated in a particular arrangement for ease of illustration and one skilled in the art will appreciate that other arrangements are possible. Moreover, while some example features are illustrated, various other features have not been illustrated for the sake of brevity and so as not to obscure pertinent aspects of the example implementations disclosed herein.

The artificial-reality system 700 may also provide feedback to the user that the action was performed. The provided feedback may be visual via the electronic display in the head-mounted display 714 (e.g., displaying the simulated hand as it picks up and lifts the virtual coffee mug) and/or haptic feedback via the haptic assembly 822 in the device 820. For example, the haptic feedback may prevent (or, at a minimum, hinder/resist movement of) one or more of the user's fingers from curling past a certain point to simulate the sensation of touching a solid coffee mug. To do this, the device 820 changes (either directly or indirectly) a pressurized state of one or more of the haptic assemblies 822. Each of the haptic assemblies 822 includes a mechanism that, at a minimum, provides resistance when the respective haptic assembly 822 is transitioned from a first pressurized state (e.g., atmospheric pressure or deflated) to a second pressurized state (e.g., inflated to a threshold pressure). Structures of haptic assemblies 822 can be integrated into various devices configured to be in contact or proximity to a user's skin, including, but not limited to devices such as glove worn devices, body worn clothing device, headset devices (e.g., wearable-glove device 104 described in reference to FIGS. 1A-4).

As noted above, the haptic assemblies 822 described herein are configured to transition between a first pressurized state and a second pressurized state to provide haptic feedback to the user. Due to the ever-changing nature of artificial reality, the haptic assemblies 822 may be required to transition between the two states hundreds, or perhaps thousands of times, during a single use. Thus, the haptic assemblies 822 described herein are durable and designed to quickly transition from state to state. To provide some context, in the first pressurized state, the haptic assemblies 822 do not impede free movement of a portion of the wearer's body. For example, one or more haptic assemblies 822 incorporated into a glove are made from flexible materials that do not impede free movement of the wearer's hand and fingers (e.g., an electrostatic-zipping actuator). The haptic assemblies 822 are configured to conform to a shape of the portion of the wearer's body when in the first pressurized state. However, once in the second pressurized state, the haptic assemblies 822 are configured to impede free movement of the portion of the wearer's body. For example, the respective haptic assembly 822 (or multiple respective haptic assemblies) can restrict movement of a wearer's finger (e.g., prevent the finger from curling or extending) when the haptic assembly 822 is in the second pressurized state. Moreover, once in the second pressurized state, the haptic assemblies 822 may take different shapes, with some haptic assemblies 822 configured to take a planar, rigid shape (e.g., flat and rigid), while some other haptic assemblies 822 are configured to curve or bend, at least partially.

As a non-limiting example, the system 8 includes a plurality of devices 820-A, 820-B, . . . 820-N, each of which includes a garment 802 and one or more haptic assemblies 822 (e.g., haptic assemblies 822-A, 822-B, . . . , 822-N). As explained above, the haptic assemblies 822 are configured to provide haptic stimulations to a wearer of the device 820. The garment 802 of each device 820 can be various articles of clothing (e.g., gloves, socks, shirts, or pants), and thus, the user may wear multiple devices 820 that provide haptic stimulations to different parts of the body. Each haptic assembly 822 is coupled to (e.g., embedded in or attached to) the garment 802. Further, each haptic assembly 822 includes a support structure 804 and at least one bladder 806. The bladder 806 (e.g., a membrane) is a sealed, inflatable pocket made from a durable and puncture resistance material, such as thermoplastic polyurethane (TPU), a flexible polymer, or the like. The bladder 806 contains a medium (e.g., a fluid such as air, inert gas, or even a liquid) that can be added to or removed from the bladder 806 to change a pressure (e.g., fluid pressure) inside the bladder 806. The support structure 804 is made from a material that is stronger and stiffer than the material of the bladder 806. A respective support structure 804 coupled to a respective bladder 806 is configured to reinforce the respective bladder 806 as the respective bladder changes shape and size due to changes in pressure (e.g., fluid pressure) inside the bladder.

The system 800 also includes a controller 814 and a pressure-changing device 810. In some embodiments, the controller 814 is part of the computer system 830 (e.g., the processor of the computer system 830). The controller 814 is configured to control operation of the pressure-changing device 810, and in turn operation of the devices 820. For example, the controller 814 sends one or more signals to the pressure-changing device 810 to activate the pressure-changing device 810 (e.g., turn it on and off). The one or more signals may specify a desired pressure (e.g., pounds-per-square inch) to be output by the pressure-changing device 810. Generation of the one or more signals, and in turn the pressure output by the pressure-changing device 810, may be based on information collected by sensors 725 in FIGS. 7A and 7B. For example, the one or more signals may cause the pressure-changing device 810 to increase the pressure (e.g., fluid pressure) inside a first haptic assembly 822 at a first time, based on the information collected by the sensors 725 in FIGS. 7A and 7B (e.g., the user makes contact with the artificial coffee mug). Then, the controller may send one or more additional signals to the pressure-changing device 810 that cause the pressure-changing device 810 to further increase the pressure inside the first haptic assembly 822 at a second time after the first time, based on additional information collected by the sensors 118A-118C and/or 171 (e.g., the user grasps and lifts the artificial-reality rock 108). Further, the one or more signals may cause the pressure-changing device 810 to inflate one or more bladders 806 in a first device 820-A, while one or more bladders 806 in a second device 820-B remain unchanged. Additionally, the one or more signals may cause the pressure-changing device 810 to inflate one or more bladders 806 in a first device 820-A to a first pressure and inflate one or more other bladders 806 in the first device 820-A to a second pressure different from the first pressure. Depending on the number of devices 820 serviced by the pressure-changing device 810, and the number of bladders therein, many different inflation configurations can be achieved through the one or more signals and the examples above are not meant to be limiting.

The system 800 may include an optional manifold 812 between the pressure-changing device 810 and the devices 820. The manifold 812 may include one or more valves (not shown) that pneumatically couple each of the haptic assemblies 822 with the pressure-changing device 810 via tubing 808. In some embodiments, the manifold 812 is in communication with the controller 814, and the controller 814 controls the one or more valves of the manifold 812 (e.g., the controller generates one or more control signals). The manifold 812 is configured to switchably couple the pressure-changing device 810 with one or more haptic assemblies 822 of the same or different devices 820 based on one or more control signals from the controller 814. In some embodiments, instead of using the manifold 812 to pneumatically couple the pressure-changing device 810 with the haptic assemblies 822, the system 800 may include multiple pressure-changing devices 810, where each pressure-changing device 810 is pneumatically coupled directly with a single (or multiple) haptic assembly 822. In some embodiments, the pressure-changing device 810 and the optional manifold 812 can be configured as part of one or more of the devices 820 (not illustrated) while, in other embodiments, the pressure-changing device 810 and the optional manifold 812 can be configured as external to the device 820. A single pressure-changing device 810 may be shared by multiple devices 820.

In some embodiments, the pressure-changing device 810 is a pneumatic device, hydraulic device, a pneudraulic device, or some other device capable of adding and removing a medium (e.g., fluid, liquid, gas) from the one or more haptic assemblies 822.

The devices shown in FIG. 8 may be coupled via a wired connection (e.g., via busing 809). Alternatively, one or more of the devices shown in FIG. 8 may be wirelessly connected (e.g., via short-range communication signals). Having thus described example wrist-wearable device, example head-wearable devices, and example feedback devices, attention will now be turned to example systems that integrate one or more of the devices described above.

### Example Systems

FIGS. 7A and 7B are block diagrams illustrating an example artificial-reality system in accordance with some embodiments. The system 700 includes one or more devices for facilitating an interactivity with an artificial-reality environment in accordance with some embodiments. For example, the head-wearable device 711 can present to the user 7015 with a user interface within the artificial-reality environment. As a non-limiting example, the system 700 includes one or more wearable devices, which can be used in conjunction with one or more computing devices. In some embodiments, the system 700 provides the functionality of a virtual-reality device, an augmented-reality device, a mixed-reality device, hybrid-reality device, or a combination thereof. In some embodiments, the system 700 provides the functionality of a user interface and/or one or more user applications (e.g., games, word processors, messaging applications, calendars, clocks, etc.).

The system 700 can include one or more of servers 770, electronic devices 774 (e.g., a computer, 774a, a smartphone 774b, a controller 774c, and/or other devices), head-wearable devices 711 (e.g., the AR system 600 or the VR system 650), and/or wrist-wearable devices 788 (e.g., the wrist-wearable device 7020). In some embodiments, the one or more of servers 770, electronic devices 774, head-wearable devices 711, and/or wrist-wearable devices 788 are communicatively coupled via a network 772. In some embodiments, the head-wearable device 711 is configured to cause one or more operations to be performed by a communicatively coupled wrist-wearable device 788, and/or the two devices can also both be connected to an intermediary device, such as a smartphone 774b, a controller 774c, or other device that provides instructions and data to and between the two devices. In some embodiments, the head-wearable device 711 is configured to cause one or more operations to be performed by multiple devices in conjunction with the wrist-wearable device 788. In some embodiments, instructions to cause the performance of one or more operations are controlled via an artificial-reality processing module 745. The artificial-reality processing module 745 can be implemented in one or more devices, such as the one or more of servers 770, electronic devices 774, head-wearable devices 711, and/or wrist-wearable devices 788. In some embodiments, the one or more devices perform operations of the artificial-reality processing module 745, using one or more respective processors, individually or in conjunction with at least one other device as described herein. In some embodiments, the system 700 includes other wearable devices not shown in FIG. 7A and FIG. 7B, such as rings, collars, anklets, gloves, and the like.

In some embodiments, the system 700 provides the functionality to control or provide commands to the one or more computing devices 774 based on a wearable device (e.g., head-wearable device 711 or wrist-wearable device 788) determining motor actions or intended motor actions of the user. A motor action is an intended motor action when before the user performs the motor action or before the user completes the motor action, the detected neuromuscular signals travelling through the neuromuscular pathways can be determined to be the motor action. Motor actions can be detected based on the detected neuromuscular signals, but can additionally (using a fusion of the various sensor inputs), or alternatively, be detected using other types of sensors (such as cameras focused on viewing hand movements and/or using data from an inertial measurement unit that can detect characteristic vibration sequences or other data types to correspond to particular in-air hand gestures). The one or more computing devices include one or more of a head-mounted display, smartphones, tablets, smart watches, laptops, computer systems, augmented reality systems, robots, vehicles, virtual avatars, user interfaces, a wrist-wearable device, and/or other electronic devices and/or control interfaces.

In some embodiments, the motor actions include digit movements, hand movements, wrist movements, arm movements, pinch gestures, index finger movements, middle finger movements, ring finger movements, little finger movements, thumb movements, hand clenches (or fists), waving motions, and/or other movements of the user's hand or arm.

In some embodiments, the user can define one or more gestures using the learning module. In some embodiments, the user can enter a training phase in which a user defined gesture is associated with one or more input commands that when provided to a computing device cause the computing device to perform an action. Similarly, the one or more input commands associated with the user-defined gesture can be used to cause a wearable device to perform one or more actions locally. The user-defined gesture, once trained, is stored in the memory 760. Similar to the motor actions, the one or more processors 750 can use the detected neuromuscular signals by the one or more sensors 725 to determine that a user-defined gesture was performed by the user.

The electronic devices 774 can also include a communication interface 715, an interface 720 (e.g., including one or more displays, lights, speakers, and haptic generators), one or more sensors 725, one or more applications 735, an artificial-reality processing module 745, one or more processors 750, and memory 760. The electronic devices 774 are configured to communicatively couple with the wrist-wearable device 788 and/or head-wearable device 711 (or other devices) using the communication interface 715. In some embodiments, the electronic devices 774 are configured to communicatively couple with the wrist-wearable device 788 and/or head-wearable device 711 (or other devices) via an application programming interface (API). In some embodiments, the electronic devices 774 operate in conjunction with the wrist-wearable device 788 and/or the head-wearable device 711 to determine a hand gesture and cause the performance of an operation or action at a communicatively coupled device.

The server 770 includes a communication interface 715, one or more applications 735, an artificial-reality processing module 745, one or more processors 750, and memory 760. In some embodiments, the server 770 is configured to receive sensor data from one or more devices, such as the head-wearable device 711, the wrist-wearable device 788, and/or electronic device 774, and use the received sensor data to identify a gesture or user input. The server 770 can generate instructions that cause the performance of operations and actions associated with a determined gesture or user input at communicatively coupled devices, such as the head-wearable device 711.

The head-wearable device 711 includes smart glasses (e.g., the augmented-reality glasses), artificial-reality headsets (e.g., VR/AR headsets), or other head worn device. In some embodiments, one or more components of the head-wearable device 711 are housed within a body of the HMD 714 (e.g., frames of smart glasses, a body of a AR headset, etc.). In some embodiments, one or more components of the head-wearable device 711 are stored within or coupled with lenses of the HMD 714. Alternatively or in addition, in some embodiments, one or more components of the head-wearable device 711 are housed within a modular housing 706. The head-wearable device 711 is configured to communicatively couple with other electronic device 774 and/or a server 770 using communication interface 715 as discussed above.

FIG. 7B describes additional details of the HMD 714 and modular housing 706 described above in reference to 7A, in accordance with some embodiments.

The housing 706 include(s) a communication interface 715, circuitry 746, a power source 707 (e.g., a battery for powering one or more electronic components of the housing 706 and/or providing usable power to the HMD 714), one or more processors 750, and memory 760. In some embodiments, the housing 706 can include one or more supplemental components that add to the functionality of the HMD 714. For example, in some embodiments, the housing 706 can include one or more sensors 725, an AR processing module 745, one or more haptic generators 721, one or more imaging devices 755, one or more microphones 713, one or more speakers 717, etc. The housing 706 is configured to couple with the HMD 714 via the one or more retractable side straps. More specifically, the housing 706 is a modular portion of the head-wearable device 711 that can be removed from head-wearable device 711 and replaced with another housing (which includes more or less functionality). The modularity of the housing 706 allows a user to adjust the functionality of the head-wearable device 711 based on their needs.

In some embodiments, the communications interface 715 is configured to communicatively couple the housing 706 with the HMD 714, the server 770, and/or other electronic device 774 (e.g., the controller 774c, a tablet, a computer, etc.). The communication interface 715 is used to establish wired or wireless connections between the housing 706 and the other devices. In some embodiments, the communication interface 715 includes hardware capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol. In some embodiments, the housing 706 is configured to communicatively couple with the HMD 714 and/or other electronic device 774 via an application programming interface (API).

In some embodiments, the power source 707 is a battery. The power source 707 can be a primary or secondary battery source for the HMD 714. In some embodiments, the power source 707 provides useable power to the one or more electrical components of the housing 706 or the HMD 714. For example, the power source 707 can provide usable power to the sensors 725, the speakers 717, the HMD 714, and the microphone 713. In some embodiments, the power source 707 is a rechargeable battery. In some embodiments, the power source 707 is a modular battery that can be removed and replaced with a fully charged battery while it is charged separately.

The one or more sensors 725 can include heart rate sensors, neuromuscular-signal sensors (e.g., electromyography (EMG) sensors), SpO2 sensors, altimeters, thermal sensors or thermal couples, ambient light sensors, ambient noise sensors, and/or inertial measurement units (IMU)s. Additional non-limiting examples of the one or more sensors 725 include, e.g., infrared, pyroelectric, ultrasonic, microphone, laser, optical, Doppler, gyro, accelerometer, resonant LC sensors, capacitive sensors, acoustic sensors, and/or inductive sensors. In some embodiments, the one or more sensors 725 are configured to gather additional data about the user (e.g., an impedance of the user's body). Examples of sensor data output by these sensors includes body temperature data, infrared range-finder data, positional information, motion data, activity recognition data, silhouette detection and recognition data, gesture data, heart rate data, and other wearable device data (e.g., biometric readings and output, accelerometer data). The one or more sensors 725 can include location sensing devices (e.g., GPS) configured to provide location information. In some embodiment, the data measured or sensed by the one or more sensors 725 is stored in memory 760. In some embodiments, the housing 706 receives sensor data from communicatively coupled devices, such as the HMD 714, the server 770, and/or other electronic device 774. Alternatively, the housing 706 can provide sensors data to the HMD 714, the server 770, and/or other electronic device 774.

The one or more haptic generators 721 can include one or more actuators (e.g., eccentric rotating mass (ERM), linear resonant actuators (LRA), voice coil motor (VCM), piezo haptic actuator, thermoelectric devices, solenoid actuators, ultrasonic transducers or sensors, etc.). In some embodiments, the one or more haptic generators 721 are hydraulic, pneumatic, electric, and/or mechanical actuators. In some embodiments, the one or more haptic generators 721 are part of a surface of the housing 706 that can be used to generate a haptic response (e.g., a thermal change at the surface, a tightening or loosening of a band, increase or decrease in pressure, etc.). For example, the one or more haptic generators 721 can apply vibration stimulations, pressure stimulations, squeeze simulations, shear stimulations, temperature changes, or some combination thereof to the user. In addition, in some embodiments, the one or more haptic generators 721 include audio generating devices (e.g., speakers 717 and other sound transducers) and illuminating devices (e.g., light-emitting diodes (LED)s, screen displays, etc.). The one or more haptic generators 721 can be used to generate different audible sounds and/or visible lights that are provided to the user as haptic responses. The above list of haptic generators is non-exhaustive; any affective devices can be used to generate one or more haptic responses that are delivered to a user.

In some embodiments, the one or more applications 735 include social-media applications, banking applications, health applications, messaging applications, web browsers, gaming application, streaming applications, media applications, imaging applications, productivity applications, social applications, etc. In some embodiments, the one or more applications 735 include artificial reality applications. The one or more applications 735 are configured to provide data to the head-wearable device 711 for performing one or more operations. In some embodiments, the one or more applications 735 can be displayed via a display 730 of the head-wearable device 711 (e.g., via the HMD 714).

In some embodiments, instructions to cause the performance of one or more operations are controlled via an artificial reality (AR) processing module 745. The AR processing module 745 can be implemented in one or more devices, such as the one or more of servers 770, electronic devices 774, head-wearable devices 711, and/or wrist-wearable devices 788. In some embodiments, the one or more devices perform operations of the AR processing module 745, using one or more respective processors, individually or in conjunction with at least one other device as described herein. In some embodiments, the AR processing module 745 is configured process signals based at least on sensor data. In some embodiments, the AR processing module 745 is configured process signals based on image data received that captures at least a portion of the user hand, mouth, facial expression, surrounding, etc. For example, the housing 706 can receive EMG data and/or IMU data from one or more sensors 725 and provide the sensor data to the AR processing module 745 for a particular operation (e.g., gesture recognition, facial recognition, etc.). The AR processing module 745, causes a device communicatively coupled to the housing 706 to perform an operation (or action). In some embodiments, the AR processing module 745 performs different operations based on the sensor data and/or performs one or more actions based on the sensor data.

In some embodiments, the one or more imaging devices 755 can include an ultra-wide camera, a wide camera, a telephoto camera, a depth-sensing cameras, or other types of cameras. In some embodiments, the one or more imaging devices 755 are used to capture image data and/or video data. The imaging devices 755 can be coupled to a portion of the housing 706. The captured image data can be processed and stored in memory and then presented to a user for viewing. The one or more imaging devices 755 can include one or more modes for capturing image data or video data. For example, these modes can include a high-dynamic range (HDR) image capture mode, a low light image capture mode, burst image capture mode, and other modes. In some embodiments, a particular mode is automatically selected based on the environment (e.g., lighting, movement of the device, etc.). For example, a wrist-wearable device with HDR image capture mode and a low light image capture mode active can automatically select the appropriate mode based on the environment (e.g., dark lighting may result in the use of low light image capture mode instead of HDR image capture mode). In some embodiments, the user can select the mode. The image data and/or video data captured by the one or more imaging devices 755 is stored in memory 760 (which can include volatile and non-volatile memory such that the image data and/or video data can be temporarily or permanently stored, as needed depending on the circumstances).

The circuitry 746 is configured to facilitate the interaction between the housing 706 and the HMD 714. In some embodiments, the circuitry 746 is configured to regulate the distribution of power between the power source 707 and the HMD 714. In some embodiments, the circuitry 746 is configured to transfer audio and/or video data between the HMD 714 and/or one or more components of the housing 706.

The one or more processors 750 can be implemented as any kind of computing device, such as an integrated system-on-a-chip, a microcontroller, a fixed programmable gate array (FPGA), a microprocessor, and/or other application specific integrated circuits (ASICs). The processor may operate in conjunction with memory 760. The memory 760 may be or include random access memory (RAM), read-only memory (ROM), dynamic random access memory (DRAM), static random access memory (SRAM) and magnetoresistive random access memory (MRAM), and may include firmware, such as static data or fixed instructions, basic input/output system (BIOS), system functions, configuration data, and other routines used during the operation of the housing and the processor 750. The memory 760 also provides a storage area for data and instructions associated with applications and data handled by the processor 750.

In some embodiments, the memory 760 stores at least user data 761 including sensor data 762 and AR processing data 764. The sensor data 762 includes sensor data monitored by one or more sensors 725 of the housing 706 and/or sensor data received from one or more devices communicative coupled with the housing 706, such as the HMD 714, the smartphone 774b, the controller 774c, etc. The sensor data 762 can include sensor data collected over a predetermined period of time that can be used by the AR processing module 745. The AR processing data 764 can include one or more one or more predefined camera-control gestures, user defined camera-control gestures, predefined non-camera-control gestures, and/or user defined non-camera-control gestures. In some embodiments, the AR processing data 764 further includes one or more predetermined threshold for different gestures.

The HMD 714 includes a communication interface 715, a display 730, an AR processing module 745, one or more processors, and memory. In some embodiments, the HMD 714 includes one or more sensors 725, one or more haptic generators 721, one or more imaging devices 755 (e.g., a camera), microphones 713, speakers 717, and/or one or more applications 735. The HMD 714 operates in conjunction with the housing 706 to perform one or more operations of a head-wearable device 711, such as capturing camera data, presenting a representation of the image data at a coupled display, operating one or more applications 735, and/or allowing a user to participate in an AR environment.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt-in or opt-out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A non-transitory computer-readable storage medium including instructions that, when executed by an artificial-reality system that includes a wearable device, cause the artificial-reality system to perform operations including:
after a user has donned the wearable device on a body part of the user:
obtaining, based on data from a sensor of the wearable device, one or more fit characteristics indicating how the wearable device fits on the body part of the user; and
in accordance with a determination that the user is interacting with an object within an artificial reality presented via the artificial-reality system using the wearable device, providing a fit-adjusted haptic response based (i) on the one or more fit characteristics and (ii) an emulated feature associated with the object.

2. The non-transitory computer-readable storage medium of claim 1, wherein the instructions, when executed by the artificial-reality system, further cause the artificial-reality system to perform operations including:
after a second user has donned the wearable device on a body part of the second user:
obtaining, based on data from the sensor of the wearable device, one or more second fit characteristics of the wearable device on the body part of the second user; and
in accordance with a determination that the second user is interacting with the object within an artificial reality presented via the artificial-reality system, provide an additional fit-adjusted haptic response based on the one or more second fit characteristics, wherein the additional fit-adjusted haptic response is distinct from the fit-adjusted haptic response.

3. The non-transitory computer-readable storage medium of claim 1, wherein the fit-adjusted haptic response is only provided while the user is interacting with the object.

4. The non-transitory computer-readable storage medium of claim 1, wherein:
the instructions for obtaining the one or more fit characteristics include instructions for obtaining one or more zone-specific fit characteristics at each of a plurality of fit-sensing zones of the wearable device, and
the instructions for providing the fit-adjusted haptic response include instructions for providing a respective zone-specific fit-adjusted haptic response at each of selected fit-sensing zones of the plurality of fit-sensing zones of the wearable device, wherein:
the selected fit-sensing zones correspond to areas of the wearable device determined to be in simulated contact with the object when the fit-adjusted haptic response is provided.

5. The non-transitory computer-readable storage medium of claim 4, wherein each respective zone-specific fit-adjusted haptic response is based on (i) one or more zone-specific fit characteristics.

6. The non-transitory computer-readable storage medium of claim 4, wherein the instructions for providing the fit-adjusted haptic response include instructions for each respective zone-specific fit-adjusted haptic response, include:
activating two or more haptic feedback generating components within the respective zone of the plurality of fit-sensing zones in accordance with the respective zone-specific fit-adjusted haptic response.

7. The non-transitory computer-readable storage medium of claim 6, wherein the two or more haptic feedback generating components within the respective zone of the plurality of fit-sensing zones are different from each other, allowing for nuanced zone-specific fit-adjusted haptic responses.

8. The non-transitory computer-readable storage medium of claim 1, wherein the fit-adjusted haptic response is provided via a haptic-feedback generator integrated into the wearable device.

9. The non-transitory computer-readable storage medium of claim 1, wherein obtaining one or more fit characteristics indicating how the wearable device fits on the body part of the user is obtained by recording data from a sensor different from a component that provides the fit-adjusted haptic response.

10. The non-transitory computer-readable storage medium of claim 9, wherein the sensor is an inertial measurement unit sensor, wherein data from the inertial measurement unit sensor can be used to determine performance of the fit-adjusted haptic response.

11. The non-transitory computer-readable storage medium of claim 1, wherein the instructions that, when executed by the artificial-reality system, further cause the artificial-reality system to perform operations including:
after a user has donned the wearable device on a body part of the user:
obtaining one or more fit characteristics indicating how the wearable device fits on the body part of the user; and
in accordance with a determination that the one or more fit characteristics indicate that the wearable device is properly affixed to the body part of the user, forgoing adjusting the fit-adjusted haptic response based on the one or more fit characteristics.

12. The non-transitory computer-readable storage medium of claim 1, wherein the instructions that, when executed by the artificial-reality system, further cause the artificial-reality system to perform operations including:
after providing the fit-adjusted haptic response based on the one or more fit characteristics and an emulated feature associated with the object:
obtaining an additional one or more fit characteristics indicating how the wearable device fits on the body part of the user;
in accordance with a determination that the user is interacting with the object within the artificial reality using the wearable device, providing another fit-adjusted haptic response based on the additional one or more fit characteristics and the emulated feature associated with the object.

13. The non-transitory computer-readable storage medium of claim 1, wherein:
the wearable device is a wearable-glove device;
the one or more fit characteristics indicating how the wearable device fits on the body part of the user is obtained via an inertial measurement unit (IMU) located on different parts of the wearable-glove device;
the fit-adjusted haptic response is provided by a haptic feedback generator, wherein the haptic feedback generator is configured to alter its feedback or change its shape.

14. The non-transitory computer-readable storage medium of claim 13, wherein the wearable-glove device includes a bladder that is configured to expand and contract and causes the haptic feedback generator to move closer or away from the body part of the user.

15. The non-transitory computer-readable storage medium of claim 13, wherein the wearable-glove device includes a bifurcated finger-tip sensor configured to detect forces acting on a tip of a finger of the user.

16. The non-transitory computer-readable storage medium of claim 1, wherein the fit-adjusted haptic response is provided via an inflatable bubble array or a vibrational motor.

17. The non-transitory computer-readable storage medium of claim 1, wherein the instructions that, when executed by the artificial-reality system, further cause the artificial-reality system to perform operations including:
after providing the fit-adjusted haptic response based on the one or more fit characteristics and an emulated feature associated with the object:
in accordance with a determination that the user is interacting with another object within the artificial reality using the wearable device, providing another fit-adjusted haptic response based on the one or more fit characteristics and an emulated feature associated with the other object.

18. The non-transitory computer-readable storage medium of claim 1, wherein the artificial-reality system includes a head-worn wearable device configured to display the object within the artificial reality.

19. A wearable device, comprising:
one or more programs, wherein the one or more programs are stored in memory and configured to be executed by one or more processors, the one or more programs including instructions for:
after a user has donned the wearable device on a body part of the user:
obtaining, based on data from a sensor of the wearable device, one or more fit characteristics indicating how the wearable device fits on the body part of the user; and
in accordance with a determination that the user is interacting with an object within an artificial reality presented via an artificial-reality system using the wearable device, providing a fit-adjusted haptic response based (i) on the one or more fit characteristics and (ii) an emulated feature associated with the object.
